(19) United States
(12) Patent Application Publication
(10) Pub. No.: US 2016/0019339 A1
(43) Pub. Date: Jan. 21, 2016

(54) BIOINFORMATICS TOOLS, SYSTEMS AND METHODS FOR SEQUENCE ASSEMBLY

(71) Applicant: Mercator BioLogic Incorporated, Eagle Mountain, UT (US)

(72) Inventors: Ilia Markovitch Sazonov, Anthem, AZ (US); Roger Ellis Arvisais, Eagle Mountain, UT (US)

(21) Appl. No.: 14/792,331

(22) Filed: Jul. 6, 2015

Related U.S. Application Data
(60) Provisional application No. 62/021,167, filed on Jul. 6, 2014.

(51) Int. Cl. G06F 19/22

(52) U.S. Cl. CPC G06F 19/22

(57) ABSTRACT

A method for genetic sequence assembly may include identifying a reference string of nucleobases digitally expressed in a first Mercator data structure having k rows by four columns, wherein k is a number of nucleobases in said string and each column attribute corresponds to a nucleobase residue by type; creating a first plurality of reference signatures of a predetermined length for the reference string; receiving an input string of nucleobases to be sequenced; creating a digital expression of the input string in a second Mercator data structure having k rows by four columns; creating a second plurality of reference signatures of the predetermined length for the input string; comparing each of the second plurality of reference signatures with each of the first plurality of reference signatures to identify possible matches of the second plurality of reference signatures with the first plurality of reference signatures; and identifying a match between at least one of the second plurality of reference signatures with at least one of the first plurality of reference signatures.

### CROSS REFERENCE TO RELATED APPLICATION

This application claims the benefit of U.S. Provisional Patent Application No. 62/021,167, filed on Jul. 6, 2014.

### FIELD

The embodiments discussed herein are related to the fields of computational biology, genomics, and comparative genetics, and more specifically to the field of string bioinformatics as applied to nucleic acid sequence alignment and assembly.

### BACKGROUND

The collective genome of the biosphere holds an extraordinary trove of information about the organization and functions of individual cells, organisms, and systems of cells and organisms that has value beyond the sum of its parts. Even before an initial 2001 report of a whole human exome [Lander et al, 2001, Initial sequencing and analysis of the human genome, Nature 409:860-921] the scope of both the opportunity and the problem had become clear. At the nanoscale, individual nucleic acid bases of nucleic acid polymers are relatively indistinguishable, and thus are difficult to sequence in long readstrings. At a second level, which is essentially computational, sequence assembly and related tasks are hindered by the use of computing machines controlled by instruction sets with limited throughput, such that chromosomal sequence assembly, and processing may take days, weeks or even months from component sequence fragments. Mere storage and annotation of the data also may also be a problem. Thus a world of genome biology still remains largely unexplored.

Similarly, analytical tasks such as gene discovery, single nucleotide polymorphism (SNP) identification, indel identification, sequence matching, probe design, homology searches and the like, continue to be hampered by the relative slowness of computers in handling the ACGT base code of a gene (herein referred to as “the genetic alphabet”). In fact, storage alone of the exabytes or yottabytes of information likely to be needed for comprehensive study continues to increase exponentially in databases such as EMBL, GenBank, NCBI, HapMap, and in private repositories, much of the data is essentially inaccessible because of the slowness of the processes needed to search, align, assemble, index and annotate the sequences. These issues of access and analysis have implications not only in medicine, but also for agronomy, animal husbandry, ecology, and biology in general, including systems biology, and there are analogous problems in accessing and manipulating protein sequence databases.

A sense of the scale of the problem is illustrated in FIG. 1, where a metaphase karyosome of a normal human genome is represented. The chromosomes of a human cell total an ordered sequence of approximately three billion nucleobases, and much of the sequence remains unknown, particularly sequences outside the exome. New human genes and epigenes are still being discovered and inter-individual genetic variability has already resulted in a whole new field of medicine.

Most conventional sequence matching is done by constructing hash tables to compare the nucleotide sequence (e.g., ACGT sequence) of two strings. These conventional methods include the Needleman-Wunsch string matrix method, for example as shown in FIG. 2A, and the Smith-Waterman method. Other conventional techniques may be inefficient and may take a significant amount of time (multiple months) to accurately assemble a single human chromosome of the 23 pairs of chromosomes of the human genome. Other techniques may take advantage of known reference sequences (a technique known as “re-sequencing”) to achieve faster sequencing, but must also make compromises on accuracy. Small gaps in the raw data degrade accuracy, and are compensated by increasing redundancy of the reads (typically with coverage of about 40× or more). Re-sequencing to speed the process at low stringency typically may still take more than a week to report a human exome, which is a subset of the human genome. Conventional techniques may have a limit on the maximum size of numeric values.

This limit defines the maximum length of strings that can be represented in an instruction at any time. For example, in a technology stack having a numeric value precision of 38 significant digits, 22 bytes are needed to store a vector value. So to store 4 numbers requires 88 bytes for a 126 character string and is the longest string that can be stored as a vector computation. In contrast, representing a 126 character string as ACGT may exceed the capacity of a technology stack as readily available and would require a division of the string into substrings for searching, thus adding to the overall inefficiency of conventional approaches.

The power of sequencing in the study of life, its processes, and its place in the natural world is unarguable, but there has been a long-standing unmet need for computational tools, systems and methods that overcome the computational difficulties in sequence assembly and analysis. Also an unmet need is a technique with the capacity to process input strings of up to a threshold limit (e.g., 250 Mbytes) without using prodigious amounts of memory and processing power. Yet more advantageously, a tool is needed that may be used in a variety of code and database environments. These and other needs are addressed by the data structures, database programming tools, methods, and computing systems of the current invention.

### SUMMARY

According to an aspect of an embodiment, a method for genetic sequence assembly may include identifying a reference string of nucleobases digitally expressed in a first Mercator data structure having k rows by four columns, wherein k is a number of nucleobases in said string and each column attribute corresponds to a nucleobase residue by type; creating a first plurality of reference signatures of a predetermined length for the reference string; receiving an input string of nucleobases to be sequenced; creating a digital expression of the input string in a second Mercator data structure having k rows by four columns; creating a second plurality of reference signatures of the predetermined length for the input string; comparing each of the second plurality of reference signatures with each of the first plurality of reference signatures to identify possible matches of the second plurality of reference signatures with the first plurality of reference signatures; and identifying a match between at least one of the second plurality of reference signatures with at least one of the first plurality of reference signatures.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a view of the human karyotype as background to the invention;

FIG. 2 is a sample showing a septamer sequence alignment by the Needleman-Wunsch method of the background art;

FIG. 3A is a sample showing a Mercator Matrix;

FIG. 3B is an example Mercator data structure having a table including Sequence ID, OFFSET (0−P), and Mercator Matrices (0−P) generated by offsetting an index position according to the OFFSET column;

FIG. 4A shows a schematic view of a readstring of an indexed Mercator Sequence Matrix;

FIG. 4B is a schematic view of a string of an indexed Mercator Sequence Matrix;

FIG. 4C is a schematic view of a string of an indexed Mercator Sequence Matrix;

FIG. 5 is a schematic of a process overview for sequence assembly using Mercator data structures of a relational database;

FIG. 6A is a schematic of a Mercator Prism sequence alignment process using ALIGN.MATCH software code, and three database tables, SHOEBOX, OFFSET, and SIGNPOST;

FIG. 6B is a schematic of a Mercator Sequence Prism alignment process using ALIGN.MATCH software code, and three database tables, SHOEBOX, OFFSET, and REFSEQ.

FIGS. 7A and 7B are illustrations of arrays having Mercator Prism data structures for sequence alignment and matching;

FIG. 8 shows a Mercator Prism conceptually as a relationship between three arrays;

FIG. 9 is exemplary code in SQL language for constructing a Mercator Matrix convolution from raw sequence data, and a Mercator Prism sequence alignment process for comparing a first Mercator Matrix of SHOEBOX with a first Mercator Matrix from a library of SIGNPOST matrices;

FIG. 10A depicts an alignment of a readstring on a REFSEQ sequence by use of Mercator Matrix convolutions (representing the stepped oligomers), where each step is generated according to an OFFSET;

FIG. 10B depicts contig assembly results;

FIG. 10C depicts a step of a chromosome walk using de novo sequence alignment;

FIG. 10D depicts a sidestep process used in aligning sequences identified from a library of sequences such as ALU (the library is termed here, REPEAT_SEQ) those sequences having multiple copies dispersed in a genome;

FIG. 11A shows a process for de novo assembly of readstrings into contigs and contigs into chromosomes using Mercator Matrix transformation and signaturizing;

FIGS. 11B through 11D detail a series of matrix transformations and radix conversion as steps in a process of convoluting, transforming and signaturizing indexed sequences from SHOEBOX (and from SIGNPOST, REFSEQ or other sequence libraries) in preparation for matching;

FIG. 12 is a view of a directory of Mercator Matrix elements as signatures, each signature representing the head or tail of a string;

FIG. 13 shows an exemplary MAP array listing any matching end sequences from the strings of FIGS. 11A through 12;

FIG. 14 is a view of an exemplary NODE_IO array, listing the number of arcs joining end matches of the strings of FIG. 13;

FIG. 15 is a view of a contig assembly deduced from FIG. 13 and FIG. 14;

FIG. 16 is a schematic describing steps of an alignment and assembly operation;

FIG. 17A is an exemplary Mercator Matrix having an expanded number of columns to include an exemplary epigenetic attribute termed “mC”;

FIG. 17B is an exemplary Mercator Matrix including a column for “quality score” (Qf) annotations;

FIG. 18 is an exemplary Mercator Matrix transposed to show a complementary strand sequence having an identical signature to that of FIG. 17B;

FIG. 19 is a view of a computing machine that embodies technical features of the inventive Mercator data structures for sequence alignment, assembly, matching and comparative genetics;

FIGS. 20A-20B are composite views of a computing machine embodying heuristic features of the inventive database management systems and programming for sequence alignment, assembly, matching and comparative genetics;

FIG. 20C is a detail view of a database clustered computing process;

FIG. 21 is a view of an encrypted reference library of genomic reference sequences derived from the inventive data management system, as accessed by multiple researchers;

FIG. 22 depicts a computer having program instructions and memory resources for executing sequencing software having Mercator data structures; and

FIG. 23 is a block diagram of a sequencing machine of the invention that incorporates on-board data processing utilizing the database structures and programming of the invention.

The drawing figures are not necessarily to scale. Certain features or components herein may be shown in somewhat schematic form and some details of conventional elements may not be shown in the interest of clarity, explanation, and conciseness. The drawing figures are hereby made part of the specification, written description and teachings disclosed herein.

### DETAILED DESCRIPTION

Current technologies for matching, sequencing and assembling full chromosomes from string fragments typically rely on string matching algorithms. Nucleic acid sequences may be conventionally represented as a string of characters from the set {A,C,G,T}. Each character may correspond to a nucleobase: Adenine (A), Cytosine (C), Guanine (G), and Thymine (T). Errors in reading a sequence result in gaps in the output string, and “N” (“not read” or “null”) is used to represent any indeterminate bases. Therefore an alphabet set that allows for gaps in existing data is {A,C,G,T,N}. Software programs for matching strings of alphabetical characters representing the DNA sequences are essentially conventional spell checking programs.

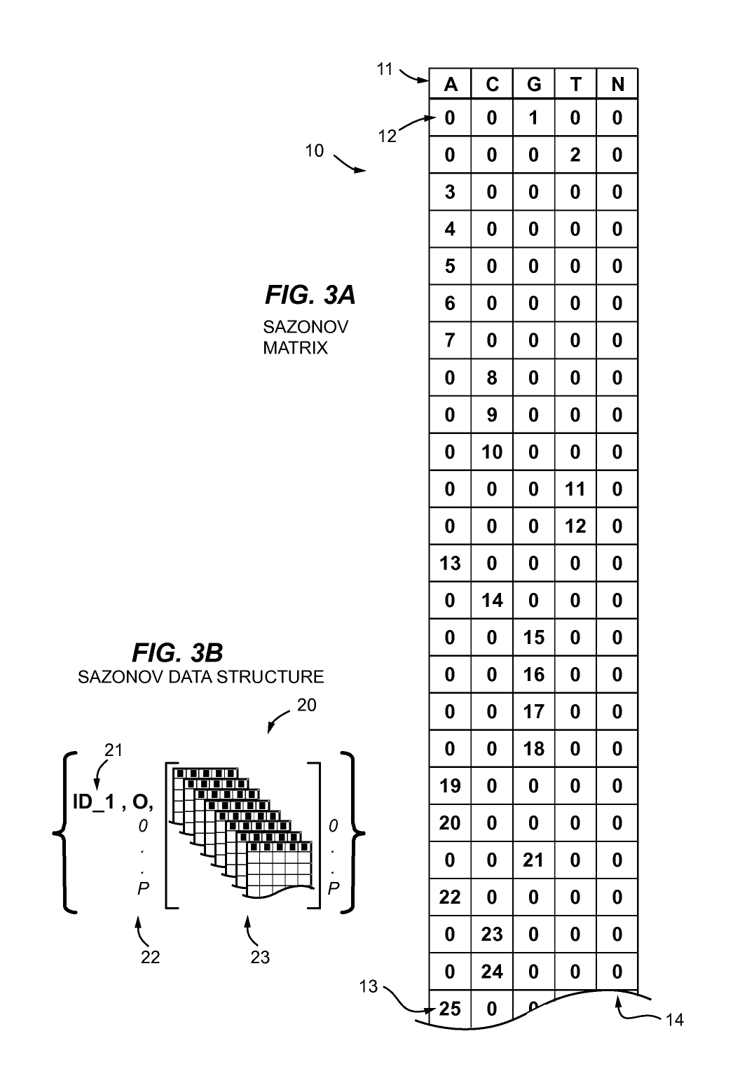

Advances in sequence matching, alignment and assembly are disclosed here. In an embodiment, a process of “convolution” is applied to reduce the alphabetical symbol strings to a data structure formed as a matrix of elemental integer values, which may be referred to herein as a “Mercator Matrix” (FIG. 3A) that retains the nucleobase identities, their connections to neighboring nucleobases, and their index position on the string. The Mercator Matrix data structure improves string comparisons, reduces resource demands on computer processors, and increases storage density. Because the matrix contains not only the sequence as a matrix of integers, but also an embedded natural index order (of the rows) corresponding to the sequence order, aligning sequences is substantially less computationally intensive than using hash tables.

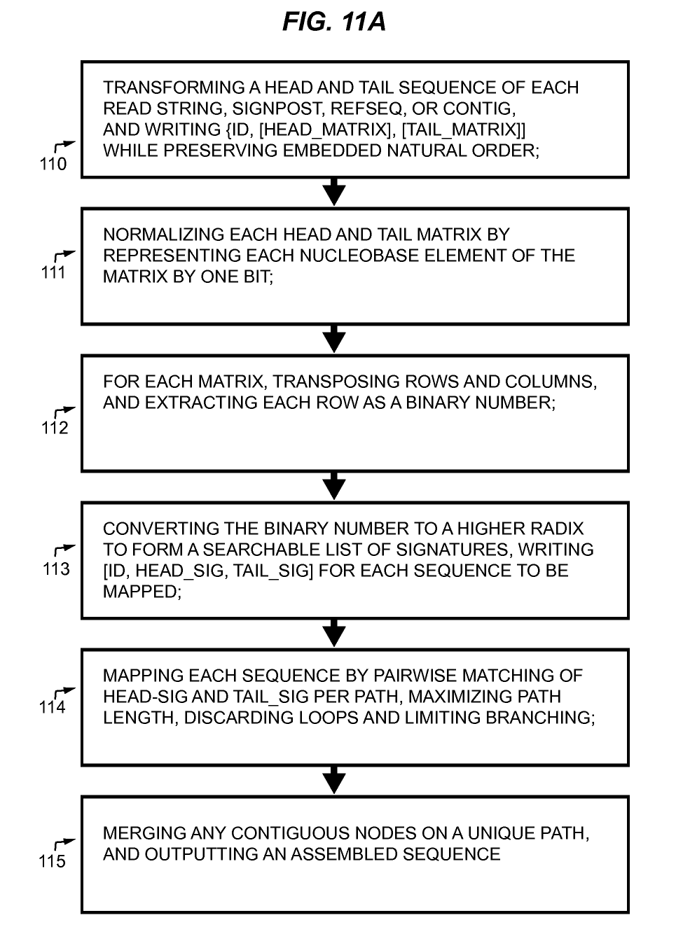

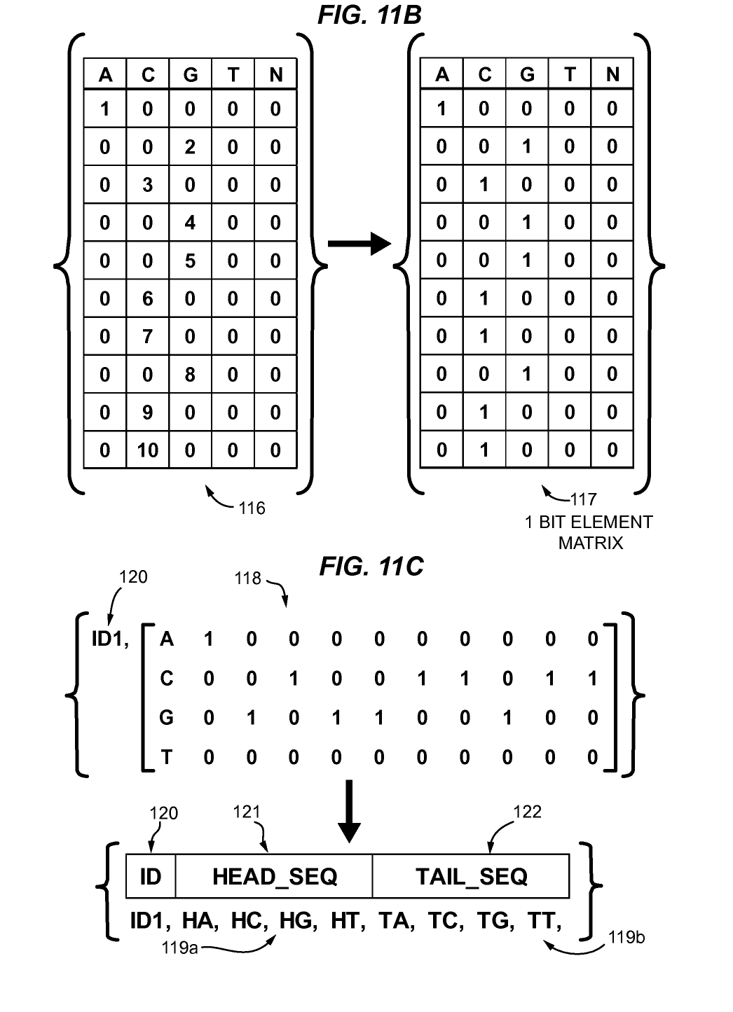

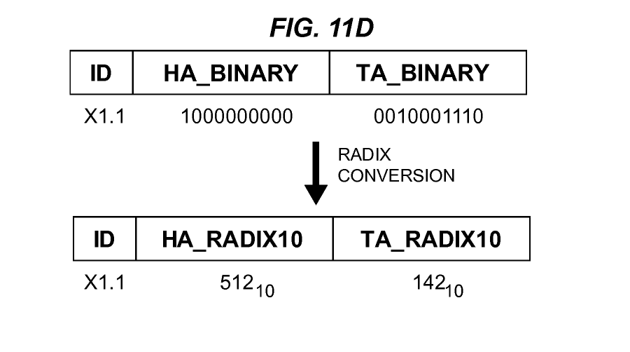

In some embodiments, the Mercator Matrix may be transformed into a “signature” that uniquely defines any unique sequence matrix of P rows up to the computer's hard limit on the size of a string. The signature may be a matrix of elements where each element includes a single bit (0 or 1) having a matrix dimension defined by its row and its column (FIG. 11B).

Signatures of 1-bit matrices are generated by flipping the row and column structure of the Mercator Matrix so that individual columns are extracted as vectors. As extracted, each column is a binary number and each row corresponds to A, C, G or T, for example. Any block of sequence data, such as an end-mer, may be expressed as a string of binary numbers, and may be compressed by conversion to a higher radix. This transformation has proved useful in end-to-end matching and alignment of string fragments. The resulting integer (in Base 10 or Base 120, for example), accompanied by an identification of the source string, may be tabulated so that signatures can be rapidly searched for matches, much like a reverse telephone directory. The matching sequences (as Mercator Matrices) may be accessed from the ID addresses in the query line and joined or merged into longer contigs according to rules established by the programmer, such as including an assembly quality factor so that alternate matches (for example variants and splice junctions) may be compared.

Certain terms are used throughout the following description to refer to particular features, steps or components, and are used as terms of description and not of limitation. As one skilled in the art will appreciate, different persons may refer to the same feature, step or component by different names. Components, steps or features that differ in name but not in structure, function or action are considered equivalent and not distinguishable, and may be substituted herein without departure from the invention. Certain meanings are defined here as intended by the inventors, i,e., they are intrinsic meanings. Other words and phrases used herein take their meaning as consistent with usage as would be apparent to one skilled in the relevant arts. The following definitions supplement those set forth elsewhere in this specification.

“Readstring”—a string of genetic alphabet symbols ACGT in the order in which they are polymerized in a nucleic acid fragment, contig, or artificial chromosome. Readstrings may sometimes have errors or gaps and are generally input as raw output from sequencing machines as determined by any of the known sequencing technologies known in the art.

“Contig”—refers to a longer “contiguous” read resulting from joining one or more overlapping collections of sequences or clones.

“Scaffold”—refers to a merged sequence resulting from connecting contigs by linking information obtained from paired-end reads of plasmids, paired-end reads from BACs, known messenger RNAs or other sources of sequence data. The contigs in a scaffold are ordered and oriented with respect to one another. Also termed “sequenced-contig-scaffolds” or “sequence-clone-scaffolds” to describe their origin. A “fingerprint-clone-scaffold” may refer to a scaffold assembled by restriction mapping.

“Shotgun sequencing”—refers to preparation and sequencing of multiple partially overlapping shorter fragments of a larger sequence unit of interest at a defined coverage equal to a pooled redundancy factor in the reads, and then aligning and merging the sequences in silico.

“Draft genome sequence”—A sequence produced by combining the information from individual sequenced clones (e.g., by creating merged sequence contigs and then employing linking information to create scaffolds) and positioning (indexing) the sequence on the physical map of the chromosomes.

Reference sequence—a longer sequence maintained in a database and used in re-sequencing new specimens. A reference sequence may have been subject to peered review and is believed reliable (but not necessarily complete). No one reference sequence can match all specimens. Because of chromosomal gender differences, genetic drift of organisms, and crossovers in ancestry, a set of reference sequences, along with a tool to rapidly select the closest reference sequence to the specimen, is needed to increase the efficiency of any re-sequencing assembly procedure.

“3′” (“3-prime”) and “5′ (“5-prime”) ends”—indicates that a nucleic acid strand is structurally directional, specifically the “5-prime end” has a free hydroxyl (or phosphate) on a 5′ carbon and the “3 prime end” has a free hydroxyl (or phosphate) on a 3′ carbon. Phosphodiester bonds grow strands from a 5′ end of a first oligomer by adding a nucleobase at a 3′-hydroxyl. A single strand may be positive sense (+) if an RNA copy of the sequence is translatable into a protein. The complementary strand is called an antisense or negative sense (−) strand. Some strands, particularly in viruses, are ambisense, and may have open reading frames in either direction. “cDNA” refers to a DNA construct formed from a library of messenger RNAs by a process of reverse transcription. Importantly, cDNA libraries lack introns and intragene sequences and are hence termed “the exome”. A true “genome” includes not only protein-encoding sequences, but also the full content of the intervening and interspersed sequences.

“Chromosome”—the structure by which hereditary information is physically transmitted from one generation to the next, generally having tertiary structure as compacted within a cell.

“Codon”—a three-nucleotide sequence of a messenger RNA that codes in translation for a specific amino acid or for a stop signal (and release of the nascent protein).

“Single nucleotide polymorphism” (SNP)—refers to a variant detected versus a reference sequence, the variant having at least one basepair substitution at a locus such that the substitution or deletion defines a measure of inter-individual variation of interest in understanding diverging or common ancestry. SNPs may be genetically linked to phenotypic variations, such as hyperactivity or inactivity in metabolizing a drug.

“Database” (DB)—as used here, is an organized collection of data contained in a server. The data are typically organized to model relevant aspects of reality in a way that supports processes requiring this information and the role of the server is to maintain and index the data, and to return an answer to a query. For example, databases may be relational, hierarchical or object oriented, and include NoSQL, XML and cloud databases, while not limited thereto. With respect to memory organization, in one embodiment, data is organized into tables defined by a relational variable, generally given as the table name, each table having one or more columns of attributes and each column having one or more rows (“tuples”) that defines a relation, where the relation is a set of one or more elements of a data domain. The term database often refers to both an organized structure of data and a DBMS for indexing, accessing and manipulating that data. In object oriented databases, the data structures may be referred to as “object classes”, the “records” are termed “objects” and the fields, “attributes”. “Table”, “row”, “column”, “attribute” and “matrix”.

“Database management systems” (DBMSs) are software applications that are compiled on database servers to implement data storage, indexing and querying. As used herein, a DBMS is a software system designed to allow the definition, creation, querying, update, and administration of databases. A list of conventional DBMSs includes: MySQL, Oracle RAC, SAP HANA, dBASE, FoxPro, IBM DB2, Adabas, LibreOffice Base, and InterSystems Cache for example.

“Query”—a tool for evaluating, manipulating and extracting data or data subsets in a database, which relies on a query language to combine the roles of definition of data, data transformation, and data query in such standards as SQL. An object model query language is used in OQL. XQuery is an XML query language, and may also be hybridized with SQL in SQL/XML.

“Data structure”—in computer science, a data structure is a particular way of organizing data in a computer so that it can be used efficiently. Different kinds of data structures are suited to different kinds of applications, and some are highly specialized to specific tasks. As applied here, a Mercator Matrix and a Mercator Prism are data structures that may be differentiated from other data structures, such as hash tables or conventional tuples of a record. Most assembly languages and some low-level languages, lack support for data structures. High-level programming and assembly languages, such as Microsoft Macro Assembler (MASM), have special syntax or other built-in support for certain data structures, such as records and arrays. For example, C++ and Pascal support structures and records, respectively, in addition to vectors (one-dimensional arrays) and multi-dimensional arrays. Modern languages usually come with standard libraries that implement the most common data structures. Examples are the C++ Standard Template Library, the Java Collections Framework, and Microsoft's .NET Framework. Modern languages also generally support modular programming, the separation between the interface of a library module and its implementation. Some provide opaque data types that allow clients to hide implementation details. Object-oriented programming languages, such as C++, Java and Smalltalk may use classes for this purpose. Many known data structures have concurrent versions that allow multiple computing threads to access the data structure simultaneously but with very large tables, parts of a large table may have to be broken out for processing or to avoid read conflicts.

A “bot” refers to a programmable instruction set for data processing that is executed as an autonomous process when provided with appropriate arguments. The bot (or a daemon) may be a process, such as a virtual machine, which iteratively repeats an instruction, a code fragment, or a “script”. Multiple “bots” can operate in a server on a common database in “threads” and may report output back to a common database manager or share the output with other bots.

“NULL” is a reserved keyword used in Structured Query Language (SQL) to indicate that a data value does not exist in the database, such as a sequence position not having a base call. Null serves to enable truth tables that support a representation of “missing information and inapplicable information”. Since Null is not a member of any data domain, it is not considered a “value”, but rather a marker (or placeholder) indicating the absence of a value.

“Hashing”—is a string comparison method that detects overlaps by consulting an alphabetized lookup table of all k-letter words in readstrings. The look-up table generally resembles a box having a first string enumerated on the top and a second string enumerated on the left such that the center diagonal from left to right may indicate the degree of similarity between the two strings.

“Join” (noun)—a join refers to a row by row comparison of two tables that outputs a sum of any identities. For example for a table having 10 rows, a complete identity is indicated by a join of 10.

“Merge”—a process of aligning sequence nodes, selecting a root node, and identifying other nodes that share an overlap. The two strings are then merged additively (X+N=X) as a union of the sets, with the exception of the overlap, which is merged as an intersection (X+X=X) of the sets.

“Anchor read” is used here to indicate a readstring or contig having a substring that is an exact match for a signpost or a reference sequence and a substring that does not match in full or in part with the same signpost or reference sequence, as would be consistent with a specimen-specific variant. Some anchor reads will fully match with a first reference sequence but not with another reference sequence. When not associated with a processing error, such variants may be classed as haplotypes, SNPs, indels, gene rearrangements, crossovers, and mutations.

“Mercator Matrix”—refers to an algebraic matrix having attributes (columns) for nucleobase type and rows corresponding to individual bases of a readstring where only one nucleobase in any row is a non-zero element. In a first embodiment, the non-zero element is a position number, such that each row is numbered in series from 1 to P, where P is the number of nucleobases in the string or block forming the body of the matrix. The matrix may include accessory columns for assigning a quality factor to each base call, and one or more columns for base substitutions such as Uracil for RNA strands and 5′methyl-Cytosine, and also for columns of null or indeterminate bases, termed “N”.

“Mercator Transformation”—also termed a “Mercator data process” or “Mercator process”, refers to any manipulation of the integers, rows, columns or attributes of a Mercator Matrix. By way of illustration, Mercator Matrices may be reduced to 1-bit matrices. Also, the attributes may be transposed so that a complementary string having an identical signature (see below) is obtained. This signature is read 5′->3′ on both strands, in opposition to conventional practice but is advantageous to sequence building where the polarity of the readstring fragments in the shoebox is unknown.

“Mercator Signature”—a string of integer values or vector representing the columns of nucleobases of a Mercator Matrix such that each integer string is an identifier for the readstring and is identical for other readstrings having identical sequences, as is advantageous in de novo sequence for end-to-end chromosome fragment walks. Unexpectedly, the signatures of this data structure may be unpacked to reform the original binary string from which they are calculated. This follows in that each signature is unique.

“Mercator Prism” is an intermediate in a sequence matching and alignment process that manifests itself as a database record having the following general structure:

{SAMPLE1_ID, SZVMTX1, OFFSET, COMPSTRING_ID, SZVMTX2}

where SAMPLE is a database having readstrings (1−N) from a specimen and COMPSTRING is a database of readstrings (1−Q) for comparison. When used in an ALIGN.MATCH query (as described below), the matrix string returns a homology value and the index position of any homology between the two strings. The Mercator Matrices are unique in expressing sequence data (strings of nucleobases) in a column structure in which the order of the bases is self-indexing and is enumerated in the natural embedded order of the rows.

“Quality Factor”—a factor indicative of the reliability of a base call at a unique position in a readstring.

“Assembly Quality Factor”—a mapping quality: as sometimes implemented using a non-negative factor p, where p is an estimate of the probability that the alignment does not correspond to the read's true point of origin. Mapping quality is related to “uniqueness.” An alignment is unique if it has a much higher alignment score than all the other possible alignments.

The bigger the spread between the best alignment's mapping quality score and the second-best alignment's score, the more unique the best alignment. As sequence assembly continues, alignments having a poor mapping quality factor may be discarded. However, accurate mapping qualities are useful for downstream tools like variant callers. For instance, a variant caller might choose to ignore evidence from alignments with mapping quality less than 10, for example. By illustration, a mapping quality of 10 or less could indicate that there is at least a 1 in 10 chance that the read truly originated elsewhere. Investigators must remain aware that transpositions, deletions and insertions may result in unexpected alignments unique to an individual or haplotype.

“Aligning pairs”—A “paired-end” or “mate-pair” read includes pair of mates, called mate 1 and mate 2. Pairs come with a prior expectation about (a) the relative orientation of the mates, and (b) the distance separating them on the original DNA molecule. Exactly what expectations hold for a given dataset depends on the lab procedures used to generate the data. For example, a common lab procedure for producing pairs yields pairs with a relative orientation of FR (“forward, reverse”) meaning that if mate 1 came from a Watson strand, then mate 2 very likely came from a Crick strand and vice versa, where the Watson strand is read 5′->3′ and the Crick strand is its complement.

“Uniqueness Factor”—a quality of an oligomer or a gene sequence having a low probability of being a degenerate repeat, and also relating to copy number, such that high uniqueness factor sequences are typically landmarks for chromosome assembly. An example is the Ubiquitin gene, variants of which appear only four times in the human genome and are readily distinguished.

“Shoebox”—a term to indicate a cache of readstring sequence fragments as would be input for computerized alignment and assembly.

“Signpost”—a term indicating a conserved sequence subset that normally has a relatively fixed position on a chromosome and occurs only once within a species. The sequence is typically a gene and may be a single-copy gene.

“Seed”—a term that indicates a readily recognized sequence having a higher degree of stability and uniqueness that can be used to anchor edgewise growth of a contig.

“Offset”—generally a one-column matrix of ascending integer values used in creating nested or truncated Mercator data structures. The role of offset in sequencing is to identify the precise index position of matched shoebox strings and to slide string A across string B when aligning possible matching readframes or end-mers. May also be used with a sidestep parameter.

“Fuzzy match”—as generally related to quality factor and assembly quality factor, refers to matches that are less than identical, but which may have biological significance, such as for identifying interindividual variability, mutation, SNPs, and errors in base calls. A conventional cutoff for a fuzzy match is 90% identity.

“Computational speed”—any means for comparing the computation velocity of a computing system as apples-to-apples. Also may refer less formally to a side-by-side comparison in which two systems are given a similar task and timed to completion. Anecdotally may refer to benchmark times given for sequencing a gene or chromosome of X Mbp and extrapolating to a larger genomic member so as to provide a sense of the speed of an improved system as a multiple of speed of a conventional or historically significant system of making assemblies.

“De novo sequencing”—a process for aligning and assembling readstrings into contigs and contigs into scaffolds in which no reference sequence or signposts are available.

“Server” refers to a software engine or a computing machine on which a software engine runs, and provides a service or services to a client software program running on the same computer or on other computers distributed over a network. A client software program typically provides a user interface and performs some or all of the processing of data or files received from the server, but the server typically maintains the data and files and processes the data requests. A “client-server model” divides processing between clients and servers, and refers to an architecture of the system that can be co-localized on a single computing machine or can be distributed throughout a network or a cloud.

A “processor”—refers to a digital device that accepts information in digital form and manipulates it for a specific result based on a sequence of programmed instructions. Processors may be used as parts of digital circuits generally including a clock, random access memory (RAM) and non-volatile memory (ROM, containing programming instructions), and may interface with other digital devices or with analog devices through I/O ports, for example.

“Real Application Cluster” (RAC) refers to an apparatus and methods for applying multiple processors simultaneously to a single database, thereby increasing computing capacity and performance and improving stability and availability of the overall computing system. The net effects of RAC are commonly referred to as “High Availability” (HA) and “Clustered Performance”. A cluster is defined as a group of independent, but connected servers, cooperating as a single system.

“Node” is a hardware element having at least the following components: a processor—the main processing component of a computer which reads from and writes to the computer's main memory; a memory used for programmatic execution and buffering of data; an interconnect (e.g., a communication link), such as LAN (local area network) or SAN (system area network) between the nodes; and a data storage device accessed by read/write commands. The nodes may incorporate a single microprocessor or multiple microprocessors in symmetrical arrays, also including “constellations.”

“Streaming parallel processing environment”, refers to processing of table structures, where single rows are processed and advanced to a next processor or nodal operation while next rows are input into a first processor or nodal operation, the consecutive processor operations being conducted on clustered arrays of nodes in a non-batchwise and non-blocking manner. Using autonomous bots at each node for threaded data processing, massively streaming parallel processing computations may be performed so as to match, align and assemble nucleic acid polymer sequences and to build and annotate reference libraries used for chromosomal, exomic, epigenetic, and genomic whole sequence bioinformatics.

General connection terms including, but not limited to “connected,” “attached,” “conjoined,” “secured,” and “affixed” are not meant to be limiting, such that structures so “associated” may have more than one way of being associated.

The terms “may,” “can,′” and “might” are used to indicate alternatives and optional features and only should be construed as a limitation if specifically included in the claims. Claims not including a specific limitation should not be construed to include that limitation. The term “a” or “an” as used in the claims does not exclude a plurality.

Unless the context requires otherwise, throughout the specification and claims that follow, the term “comprise” and variations thereof, such as, “comprises” and “comprising” are to be construed in an open, inclusive sense—as in “including, but not limited to.”

A “method” as disclosed herein refers to one or more steps or actions for achieving the described end. Unless a specific order of steps or actions is required for proper operation of the embodiment, the order and/or use of specific steps and/or actions may be modified without departing from the scope of the present invention.

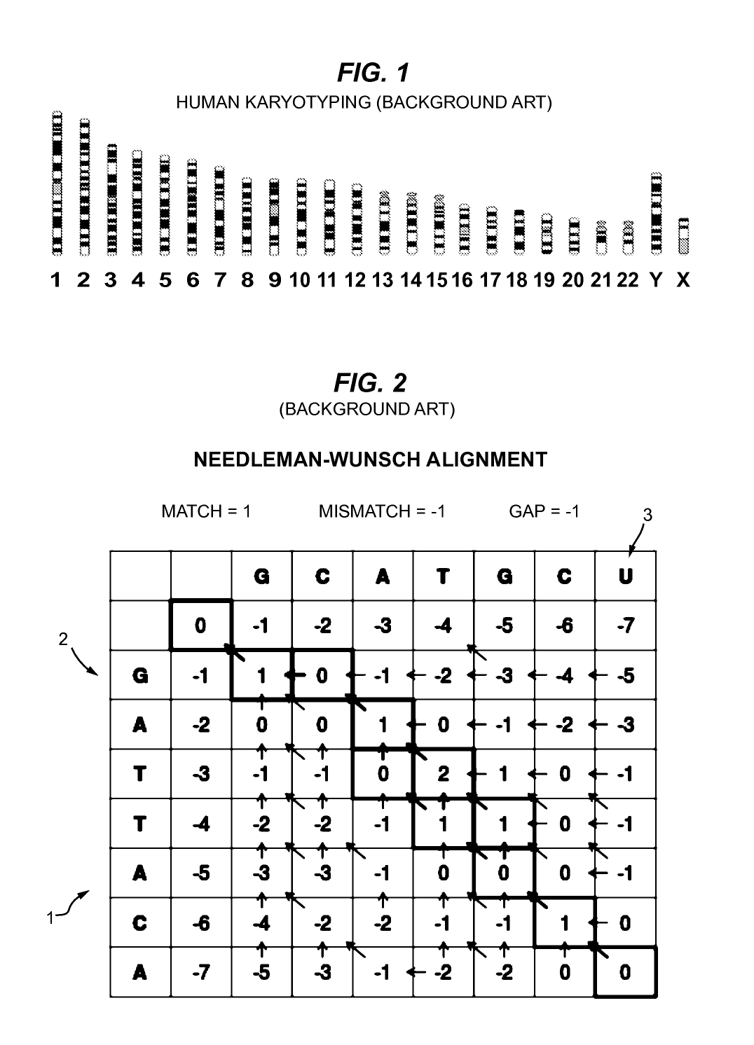

FIG. 1 lines up 24 chromatids of a human karyosome, each a haplotype. At metaphase, sister chromatids pair into the 23 diploid (pairs of) chromosomes of a dividing cell. Therefore each genome includes 46 chromatids, each of which has unique genetic information. In other words, a somatic, non-dividing cell has 46 “chromosomes” (as commonly used, “23 pairs of chromosomes”). Each chromosome is typically individually sequenced and assembled to achieve a whole genome sequence. The karyosome includes over three billion nucleobases. Currently only two such reference sequences are publically available and both are incomplete.

FIG. 2 is a sample hash table (1) showing sequence alignment of two septomers (2,3), including an RNA and a DNA strand, by the Needleman-Wunsch method. Hash tables, which are essentially a form of spell checking, form the basis of Needleman-Wunsch, Smith-Waterman, and related string-searching algorithms [see for example, Needleman, 1970, J Mol Biol 48(3):443-53; Hirschberg, 1975 Communications of the Assoc Comp Mach 18:341-43; Wagner, 1974, Journal of the ACM 21 (1): 168-173, and Farrar, 2007, Bioinformatics 23:156-61].

FIG. 3A is a sample Mercator Matrix 10 formed by convolution of a read sequence. Five columns (11) are used to represent the attributes A, C, G, T and N, where N is a null indicator. Each row (12) of each column includes an element that is an integer. All non-zero integers are place designators such that the order of the bases increases sequentially from 1 to P in the matrix, where P is the string length or nucleobase count. In this instance the row count advances from 1 to 25 (23, last row). The N column (14) contains only zeroes, indicating that no gaps in the sequence were found. The overall dimensions of the matrix are 25×5.

The model is based on representing a DNA strand as a matrix of elements, each element of which has the following attributes: A, C, G, T, and N. In a relational database management environment, a table is a database structure including rows corresponding to elements and columns designating attributes. In a Mercator Matrix, each row contains only one non-zero number; the column of the non-zero number corresponds to the nucleobase of the original string at that index position. As shown here, the non-zero number is an integer equaling the index position. Thus the table contains an “embedded natural order” as well as the full nucleobase sequence, and may be P×5 rows in length.

The table may also include Uracils, modified bases such as 5′-methyl-cytosine (mC), and a quality factor (Qf) for assessing uncertainty or tagging a gap in the base call sequence, expanding the table to P×6 dimensions. The dimensions of the table is limited by the capacity of the hardware to process longer character strings, so the capacity to elegantly represent the base sequence with embedded natural ordering improves the maximal string length that can be processed at any time.

FIG. 3B is an exemplary Mercator data structure 20 (where the outside brackets “{ }” indicate a data table structure) that includes: sequence ID (21), OFFSET (0−P) (22), and linked matrix ([ ], 23) of Mercator Matrices (matrix icons, 0−P) generated by offsetting an index position according to the OFFSET column value (0−P). Each of the matrices 0−P are linked in the table at a common index identifier, typically the string ID. For each value in the single column matrix O (“OFFSET”), the matrix is “slid” along the readstring by one base at a time. Each offset value creates a new Mercator Matrix as represented here figuratively by stacked matrix icons. OFFSET may be up to a few bases, twenty bases, thirty-five bases, or any number up to the entire length P of the string. For end-to-end fast matching, it is often economical in processing time to consider only the first and last 20 to 40 bases of the string, for example. The data structure as shown includes a single readstring identifier “ID_{—}1” (21), but advantageously, data structures may be expanded to include listing of larger numbers of readstrings that is adapted for iterative program loops.

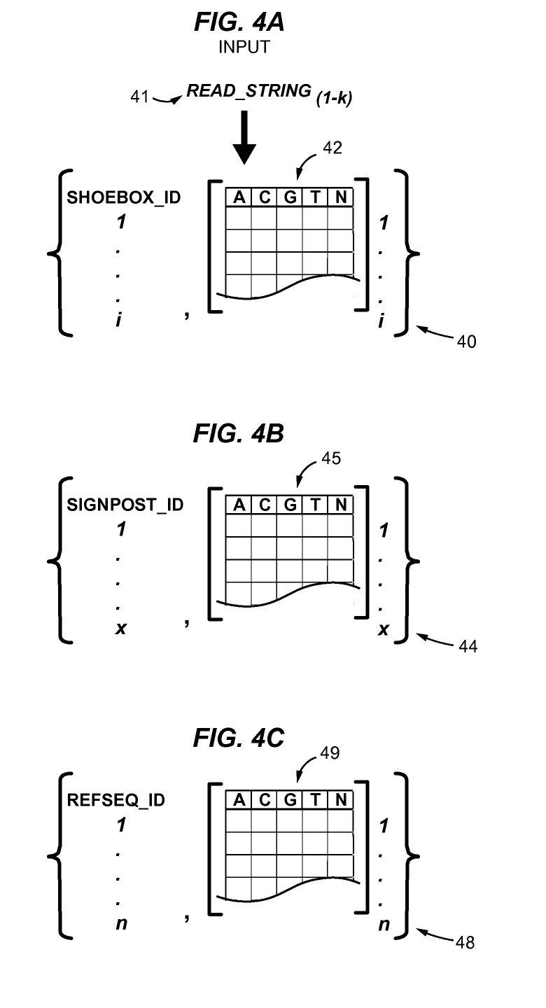

FIG. 4A shows a schematic view of an indexed data structure or seed matrix 40 having an index value and readstring represented as a Mercator Matrix. SHOEBOX is a term used to describe a library of raw sequence fragments, each having an ID, and may include other tabulated annotations referencing the specimen. Not shown is a column matrix for OFFSET, but additional matrices are readily linked to the table structure shown here, where each readstring input (41) is transformed by convolution into a Mercator Matrix, shown here as an icon 42 that represents a matrix of matrices.

FIG. 4B is a schematic view of a string of an indexed data construct 44 used to store signpost data in Mercator Matrix form. SIGNPOST is a term used to describe a library of unique sequences having a generally stable position on a chromosome. These sequences are generally not offset, but for every signpost 1 though x, a Mercator Matrix 1−x is derived and is shown here as an icon 45 that represents a matrix of matrices. SIGNPOST may include more than one species or gender during an initial round of alignments, but may be revised once the appropriate species, gender and chromosome(s) are identified. Alternatively, SIGNPOST may be expanded if initial matches are insufficient to efficiently build larger contigs and scaffolds. An iterative search process is used to compare SIGNPOST sequences with SHOEBOX sequences using clusters of concurrent matching processes executed by hundreds or thousands of bots and/or daemons under control of a chain controller of the DBMS.

FIG. 4C is a schematic view of a string of an indexed data construct 48 used to store reference sequence (REFSEQ) data in Mercator Matrix form. REFSEQ is a term used to describe a library of indexed reference sequences such as a reference chromosome. For every reference sequence or subsequence 1−n, a Mercator Matrix 1−n is derived and is shown here as an icon 49 that represents a matrix of matrices. Where multiple REFSEQ are available, initial matching may help to select a most appropriate reference sequence, such as of the appropriate gender and ancestry.

In one embodiment of the inventive sequence assembly system, any number of whole genome reference sets are indexed according to the data structure of FIG. 4C. In some embodiments, at least 96 whole genome reference sets are indexed. An iterative search and matching process is used to build contigs from readstrings, scaffolds from contigs, and chromosomes from scaffolds. Clusters of concurrent matching processes are executed by a plurality of bots or daemons as coordinated and controlled by a chain controller of a database server and DBMS. The database structures of FIGS. 4A-4C are used in combinations, as will be described below.

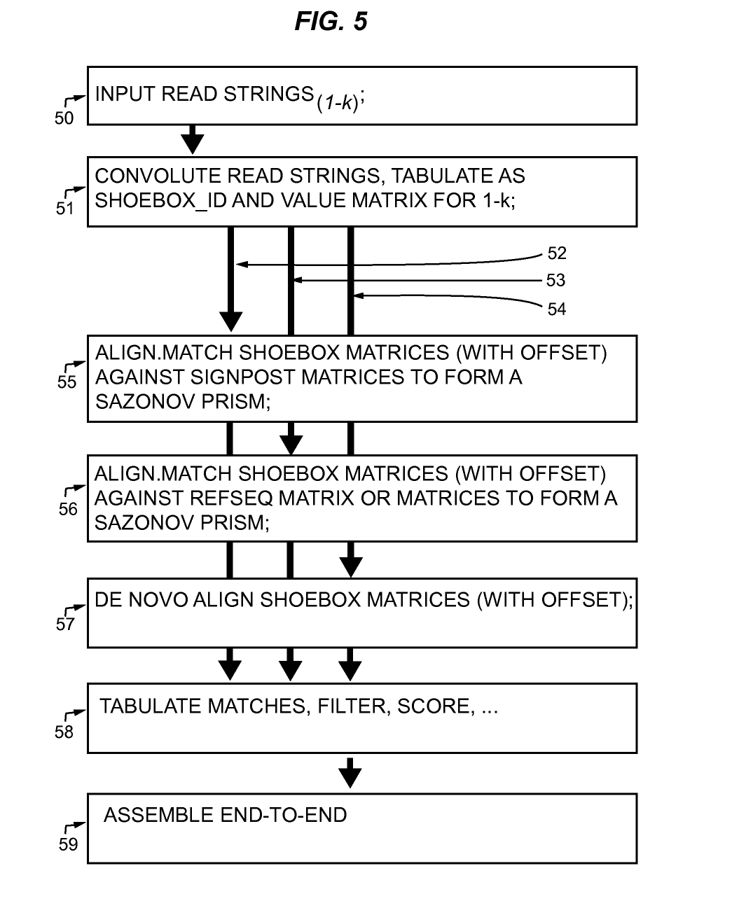

FIG. 5 is a schematic of a system overview for sequence assembly using Mercator data structures of a relational database under the control of a DBMS. Any method described herein may be performed by processing logic that may include hardware (circuitry, dedicated logic, etc.), software (such as is run on a general purpose computer system or a dedicated machine), or a combination of both, which processing logic may be included in any computer system or device. For simplicity of explanation, methods described herein are depicted and described as a series of acts. However, acts in accordance with this disclosure may occur in various orders and/or concurrently, and with other acts not presented and described herein. Further, not all illustrated acts may be required to implement the methods in accordance with the disclosed subject matter. In addition, those skilled in the art will understand and appreciate that the methods could alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media.

In block (50), readstrings are read by the processing logic (e.g., an I/O device), indexed, and deposited in memory. In block (51), the readstrings are then convoluted by a process that generates a Mercator Matrix for each readstring and the Mercator Matrices are deposited in a memory cache, termed here SHOEBOX. There may be multiple shoeboxes as needed.

The initial convolution involves a transformation of the ACGT genetic alphabet to form the matrix as shown in FIG. 3. The Mercator Matrix shown has a k×5 dimension, where “k” is the number of nucleobases in the readstring. Each attribute (column) corresponds to a nucleobase identity, A, C, G, T and N, where N is an optional column used to represent a gap in the known sequence. The Mercator Matrix is defined by the following rules, (i) each row or tuple has only one non-zero integer; (ii) the non-zero element in each row denotes the position of the corresponding nucleobase (per the attribute of the column) in the input readstring. Thus the table defines the sequence and the sequence order using embedded natural ordering. FIGS. 3, 4A-4C illustrate indexed Mercator Matrix structures figuratively.

The data model is geared towards sequencing computations in database management systems (DBMS), where programs and data reside in arrays of database servers and are operated in nodal clusters or chains under control of the server array. Contrastingly, in conventional systems, data is stored as unsorted 2-dimensional arrays (a.k.a. tables). However, the model provides natural embedded ordering, which makes is possible to utilize the power of DBMS systems for processing genomic data.

Again for comparison, conventional technologies for matching, sequencing and assembling full chromosomes from readstring fragments rely on string matching algorithms such as Smith-Waterman and Needleman-Wunsch. This process amounts to spell checking strings of characters representing the nucleobase sequences. In embodiments, convolutions reduce the genetic alphabet in the readstring to an elemental matrix of values, which are easier and faster to match, place much lower processing demands on computer resources, and require much less storage capacity.

As illustrated in the flow chart of FIG. 5, a system for matching and alignment may rely on three complementary processes at block (52, 53, 54), a process of string matching against SIGNPOST Mercator Matrices (52), a process of string matching against REFSEQ Mercator Matrices (53), and a process of DE NOVO matching (54). At any point during this process, readstrings may be combined into contigs, contigs may combined into scaffolds, and scaffolds may be further combined. SIGNPOST and REFSEQ alignment and matching are done by essentially identical processes involving a few lines of code that are executed iteratively. The computational process for matching described here is a first embodiment of a Mercator transformation and is termed a Mercator Prism alignment. DE NOVO alignment 59 is done by another operation on the Mercator Matrix, and will be described in more detail below. For cogency, the term “Mercator Prism” process shall be applied to both the transformation described here with ALIGN.MATCH and the bitwise vectorization and transformation described below with FASTQ.ENDWISE, both of which use a Mercator Matrix data structure in support of an alignment computation. Alignments and indexing from each of the complementary processes are compared and reaffirmed for match and position to ensure a higher level of confidence in the product output. These exemplary Mercator processes are not intended to limit a general class of embodiments that may be realized herefrom.

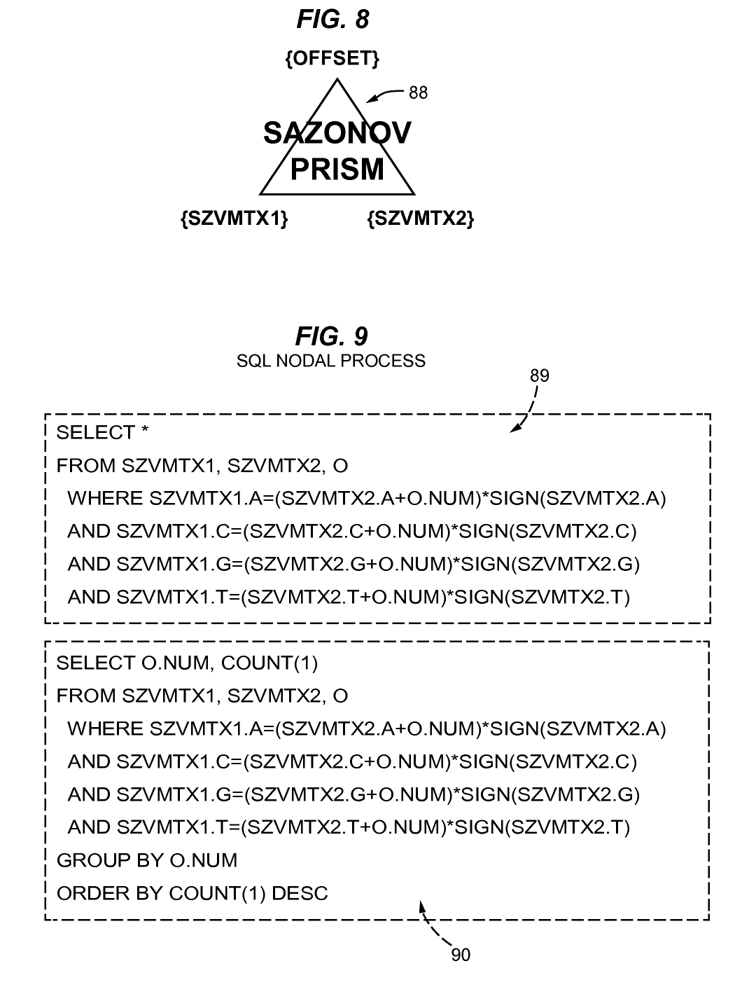

Mercator Prism alignment is a process of operations involving three matrices or tables and is depicted generally in FIG. 8, from which the term “Mercator Prism” (88) is coined. In FIG. 5, block (55) is a process of aligning readstrings with signposts. This operation is useful in narrowing down species and gender and may be used to identify a particular chromosome associated with a particular readstring or contig. Each member of the SIGNPOST table (44, 45) may be selected for its uniqueness as a conserved and stable member (generally of the genes) found on a particular chromosome. While human alignment and sequence assembly is described in detail, the process may be applied to biological and ecological sequence assembly without deviation from the method. SIGNPOST alignment (52) facilitates REFSEQ alignment (53).

ALIGN.MATCH may be referred to as a program subroutine or script that may align any two sequences by Mercator Matrix identity and may output the relative index position of the aligned sequences. The read fragment A1 may be table A1 and read fragment A2 may be table A2. The processing logic may build a join where each attribute in each row of A1 equals each attribute of each row in A2. Should A1 and A2 be identical, the result of the join will be equal to the number of rows in A1 and A2. Should A1 and A2 have different lengths and equal from their first nucleotide all the way, the result will be the lesser of the two. Should they match partially, the result of the join will immediately show the positions that matched. The join can be represented in SQL as follows:

SELECT a1.a, a1.c, a1.g, a1.t from a1, a2
where a1.a = a2.a
and a1.c = a2.c
and a1.g = a2.g
and a1.t = a2.t
and a1.n = a2.n

Should the fragments match from any position other than 1, the above command may be modified to include the offset:

SELECT a1.a, a1.c, a1.g, a1.t, offset.num from a1, a2, offset
where a1.a = a2.a +o.num*sign(a2.a)
and a1.c = a2.c + o.num*sign(a2.c)
and a1.g = a2.g + o.num*sign(a2.g)
and a1.t = a2.t + o.num*sign(a2.t)
and a1.n = a2.n + o.num*sign(a2.n)

where offset is a table with one column−num, and its values are from 0 to any reasonable number for offset. Usually the result of a1 rows minus a2 rows is the minimum values for offset num.

The above statement is a single command that returns the answer for nucleobase fragment match, the match position, and the number of matched nucleobases. Provision can also be made for partial identity. A match of nine out of ten nucleobases, for example, may be significant in identifying a variant sequence or to accommodate a gap in the sequence.

Any relational DBMS that is capable of parallel processing can handle this query with great efficiency, velocity, and scalability. This can also be written for file comparisons in a range of analytical programming languages, including such as C++, PERL, or PYTHON, while not limited thereto.

The process initially is iterated (55) for SHOEBOX (or a subset of SHOEBOX) against SIGNPOST (52). A next run (56) may include any contigs or scaffolds generated in the first run, and will compare the product strings with REFSEQ (53). In this way, larger contigs and scaffolds are assembled. Matches of each run are pooled, tabulated, filtered and scored (58), and any alignments of readstrings having a high confidence level are merged to produce a contig or a scaffold. In a final step (59), end-to-end assembly is achieved.

The processing logic may compare two fragments of a nucleobase string for areas of homology. In this computational model, the task becomes a join of two tables, or files, each representing one of the fragments. An offset is applied to one of them: by which the Mercator Matrix can be slid frame-by-frame along the string to detect the highest possible position of alignment. This algorithm may be referred to as the “Mercator Prism”, which is described pictographically in the following figures.

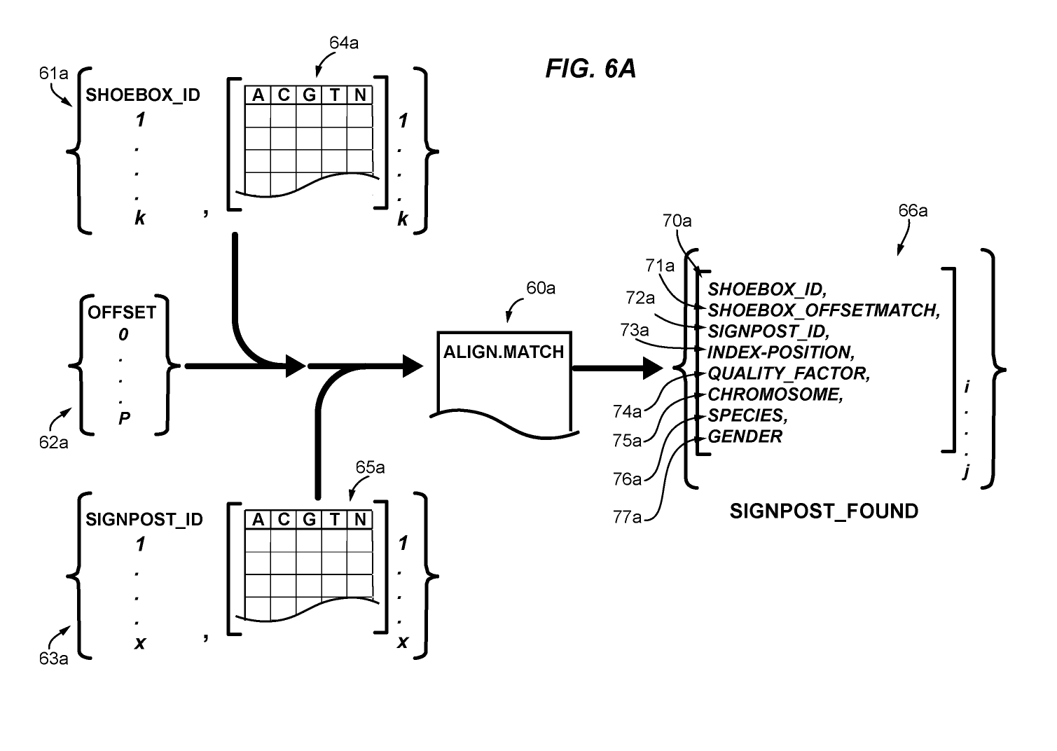

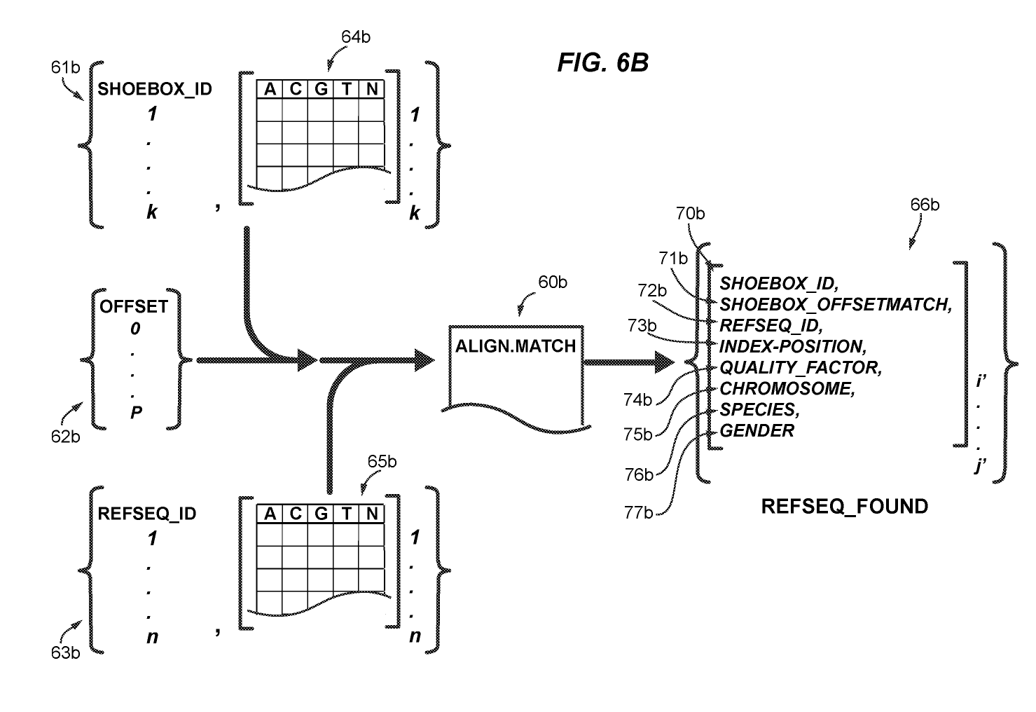

FIG. 6A is a schematic of a Mercator Prism sequence alignment process for screening specimen readstrings in SHOEBOX for matches in a SIGNPOST table. The process uses ALIGN.MATCH software code, and three database tables, SHOEBOX, OFFSET, and SIGNPOST. The iterative instructional loop responsible for Mercator indexing and convolution is arbitrarily given the name ALIGN.MATCH (60a). It can be seen that ALIGN.MATCH receives data from three tables (61a, 62a, 63a) where the sequence data is in the form of Mercator Matrices (64a,65a) and outputs a list (66a) of matches and offsets, also including annotations indexed to the input sequences.

The SHOEBOX table (61a) is an indexed list of raw sequence fragments (and any previously aligned contigs or scaffolds), where each sequence is represented as a Mercator Matrix (1−k) (64a, icon). The SIGNPOST table (63a) is an indexed list of signpost sequences (as Mercator Matrices, 65a), and are selected by the operator for efficiency in determining species, gender, chromosome number, and chromosome arm, for example.

The OFFSET table 62a is used to slide each shoebox string along each signpost string (1−x) in order to find a best alignment readframe. SHOEBOX fragments that are matched are output to the SIGNPOST_FOUND table (66a); strings that are not matched are returned to the shoebox and are available for a matching process against another signpost, or for de novo alignment and assembly (54). The details of assembly from the data of the SIGNPOST_FOUND table are described in a later section.

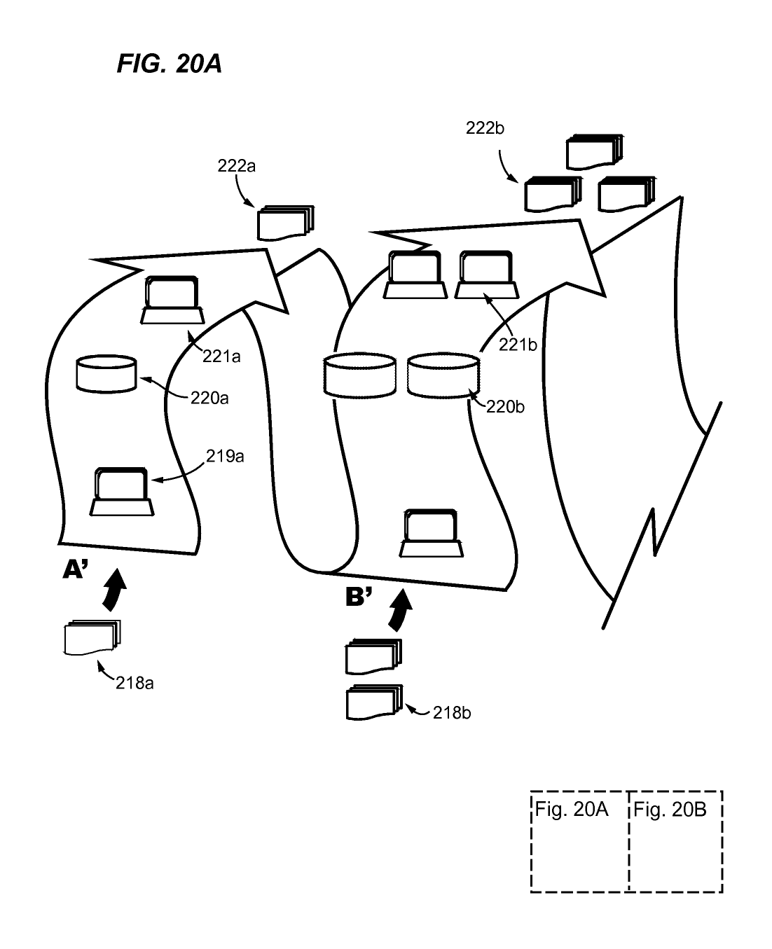

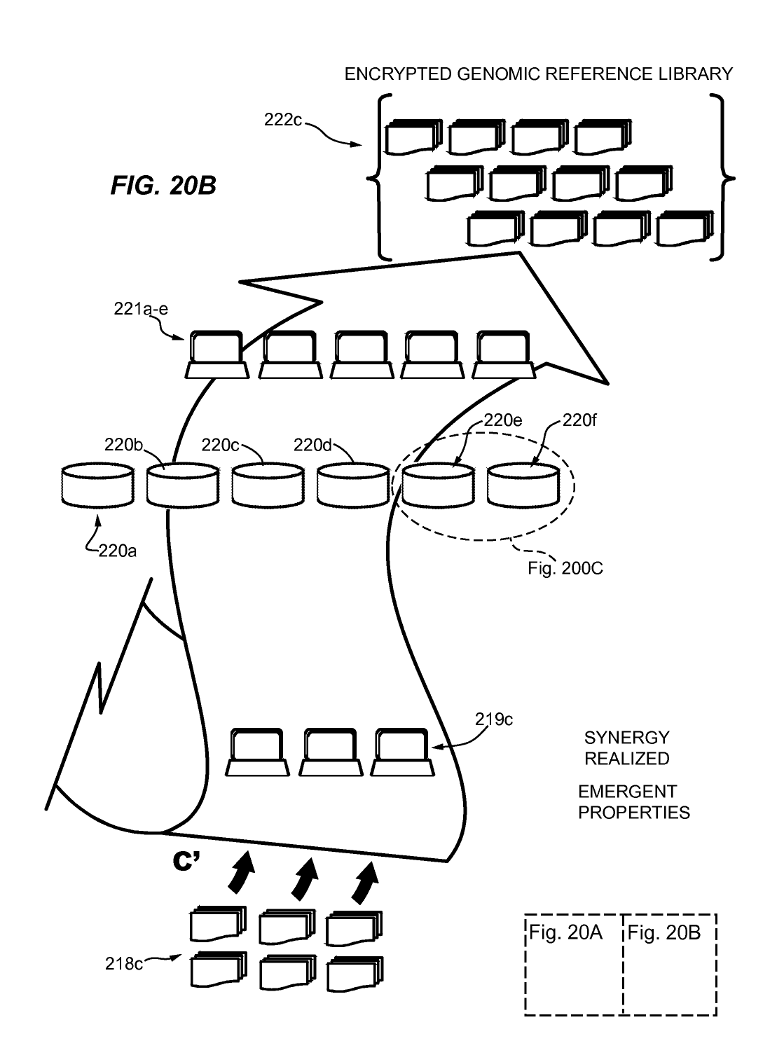

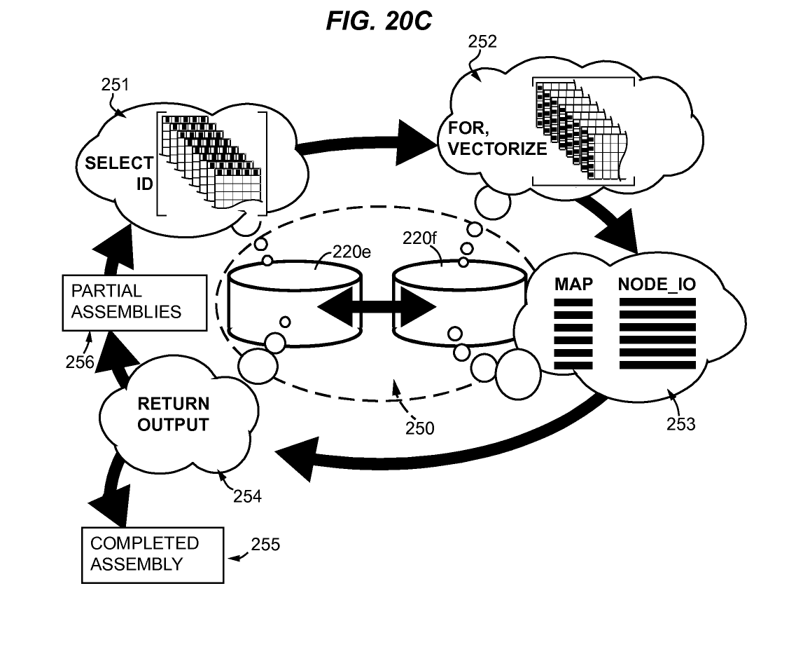

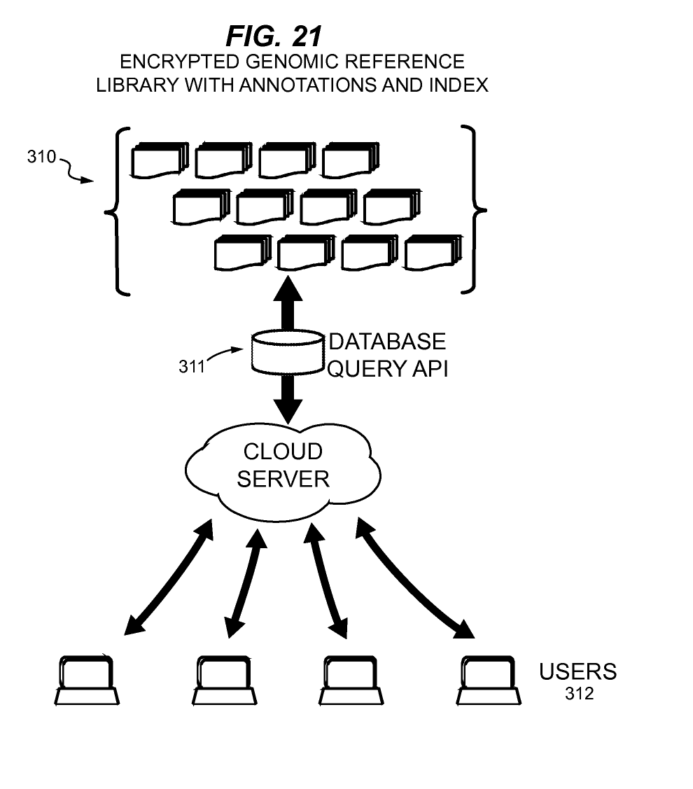

Summary table SIGNPOST_FOUND is an indexed list or string having the following attributes, SHOEBOX_ID (70a), SHOEBOX_OFFSETMATCH (71a), SIGNPOST_ID (72a), INDEX_POSITION (73a), QUALITY_FACTOR (74a), CHROMOSOME (75a), SPECIES (76a), and GENDER (77a). This information is collected and indexed during the alignment process so that it may be included in the final work product, and is curated and archived as part of a larger process of building new reference genomes (as described in FIG. 20A-20B).

In this view, a collection of readstrings (1−k) may be compared to a collection of signposts (1−x), with offsetting, and the Prism alignment process may be written in SQL to use less than 10 lines of code essentially as shown in the bottom section (91) of FIG. 9.

FIG. 6B is a schematic of a Mercator Sequence Prism alignment process using ALIGN.MATCH software code, and three database tables, SHOEBOX, OFFSET, and REFSEQ. It can be seen that ALIGN.MATCH receives data from three tables (61b, 62b, 63b) where the sequence data is in the form of Mercator Matrices (64b,65b) and outputs a list (66b) of matches and offsets, also including annotations indexed to the input sequences.

The SHOEBOX table (61b) is an indexed list of raw sequence fragments (and any previously aligned contigs or scaffolds), where each sequence is represented as a Mercator Matrix (1−k) (64b, icon). The REFSEQ table (63b) is an indexed list of REFSEQ sequences (as Mercator Matrices, 65b), and may be selected by the operator for efficiency in determining species, gender, chromosome number, and chromosome arm, for example.

The OFFSET table 62a may be used to slide each shoebox string along each reference sequence string (1×) in order to find a best alignment readframe. SHOEBOX fragments that are matched are output to the REFSEQ_FOUND table (66b); strings that are not matched are returned to the shoebox and are available for a matching process against another REFSEQ, or for de novo alignment and assembly. The details of assembly from the data of the REFSEQS_FOUND table are described in a later section.

Summary table REFSEQ_FOUND is an indexed list or string having the following attributes, SHOEBOX_ID (70b), SHOEBOX_OFFSETMATCH (71b), REFSEQ_ID (72b), INDEX_POSITION (73b), QUALITY_FACTOR (74b), CHROMOSOME (75b), SPECIES (76b), and GENDER (77b). Typically SIGNPOST_FOUND and REFSEQ_FOUND will be cumulative, or will be pooled before an assembly or chromosome build is output to a user.

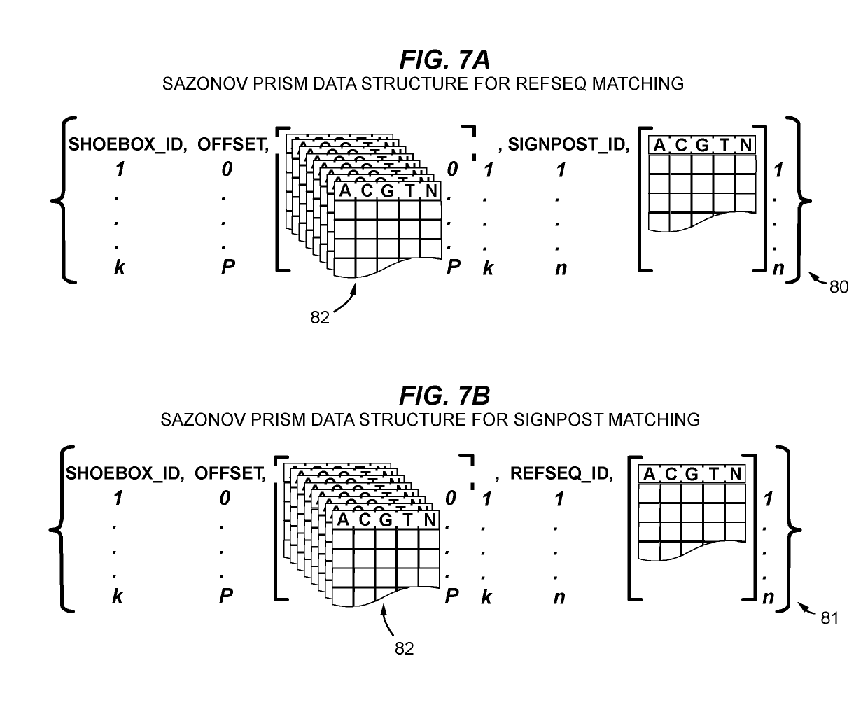

FIGS. 7A and 7B are illustrations of tables (80, 81) having Mercator Prism data structures for sequence alignment and matching. An offset column “0” (0−P) is used to generate Mercator Matrices 0−P for each indexed string in SHOEBOX, where the matrices are shown here figuratively as a stack of icons (82). In this view, an inherent symmetry and robustness of the instruction set for the Mercator Prism is illuminated by the corresponding data structure of the inputs.

FIG. 8 shows a Mercator Prism 88 conceptually as a relationship between three arrays more particularly diagrammed in FIGS. 7A and 7B, OFFSET is a one-column matrix, SZVMTX1 and SZVMTX2 are row-by-column Mercator Matrices that combine the sequence of nucleobase strings (using as column attributes the ACGT alphabet plus any epigenetic base modifications) with a natural embedded ordering of the elements. The figure describes an expression:

{SHOEBOX_ID, SZVMTX1, OFFSET, COMPSTRING_ID, SZVMTX2}

where each of the sequences to be compared are indexed and the process is fully iterative. The role of offset in sequencing is to identify the precise index position of matched shoebox strings and to “slide” string A along string B when aligning possible matching readframes or end-mers.

FIG. 9 is exemplary code in SQL language for constructing a Mercator Matrix convolution from raw sequence data (89), and a Mercator Prism sequence alignment process for comparing a first Mercator Matrix of SHOEBOX with a first Mercator Matrix from a library of SIGNPOST matrices. The code defines an iterative core process that is repeated to align readstrings with known signposts, and with reference sequences, or other readstrings. The initial match with SIGNPOST also may be used to sort readstrings from SHOEBOX and scaffolds by chromosome number.

Surprisingly, only a few lines of code may be used to generate an indexed set of Mercator Matrices, to tabulate two matrices for comparison along with an offset subroutine, and to determine any overlap in which there is a significant degree of identity.

For breadth, a more general algorithm can be constructed as follows: Consider three tables, T1, T2 and O. T1 and T2 both having columns A, C, G, T, N and data representing Matrices S1, S2; Matrix O having column NUM and data values 0 . . . 5. In order to find the best match of the two Matrices S1 and S2, an offset is used so as to maximize the number of equations of identity that are satisfied. In a multiprocessing (parallel processing) environment, each subprocess of the program runs on its own set of resources (processor node, cache memory, I/O functions). Example programming instructions may be written as follows:

```
begin
split all rows from table O into ranges;
send each range of O to a process;
split all rows from table S2 into ranges;
send each range of S2 to a process that received a range from O;
for each process {
perform merge of S2 range and O range: combine every row of S2 with
every row of O;
save the result in a temporary array TQ1;
/* this is a comment */
/* if S2 range size is n rows, and O range size is m rows, the above
operation produces a table TQ1 (2D array) of n*m rows. Every row of
the TQ1 has the same columns as S2 does,
and the values are as follows:
  for any i,j in a range (1..n*m): TQ1(i).A = (S2(i).A+O(j)) * sign(S2(i).A)
  */
  }
  split all rows from table S1 into ranges;
  send each range of S1 to a process;
  for each process {
  compute deterministic hash function of every row, store hash table in
  memory;
  for each row in TQ1:
  {
  find hash value and compare it to the hash table above;
  select to TQ2 temp table when matched;
  }
  }
  split TQ2 into ranges;
  send each range of TQ2 to a process;
  for each process {
  for each row in TQ2 range: {
  count the number of rows with the same value of O;
  for each O save counts into TQ3;
  }
  }
  for each row in TQ3: {
  if count = number of rows in S2, select O for output;
  }
  output results;
  end;
```

The output of the program is a list of offset values, which indicate a block where S2 matched S1 with identity. The offset values may be used to index the best alignment position of the two strings. Similar operations may be executed to position a readstring, a contig, or a scaffold on a reference sequence relative to a point of origin such as a telomere end, a centromere, an origin of replication, or any other suitable landmark for shared indexing of all the nucleobases of the chromosome.

The kinds of set operations illustrated here are well implemented in relational database management systems (RDBMS). In these systems, relational algebra concepts are implemented by means of Structured Query Language or SQL. The above ALIGN.MATCH algorithm is much easier represented in terms of SQL as shown in FIG. 9 (where a subroutine for convoluting raw ACGT data is shown in the upper box 89 and a subroutine for Mercator Prism matching is shown in the lower box 90) but illustrates a general approach to translating the algorithm into other programming languages across a variety of platforms.

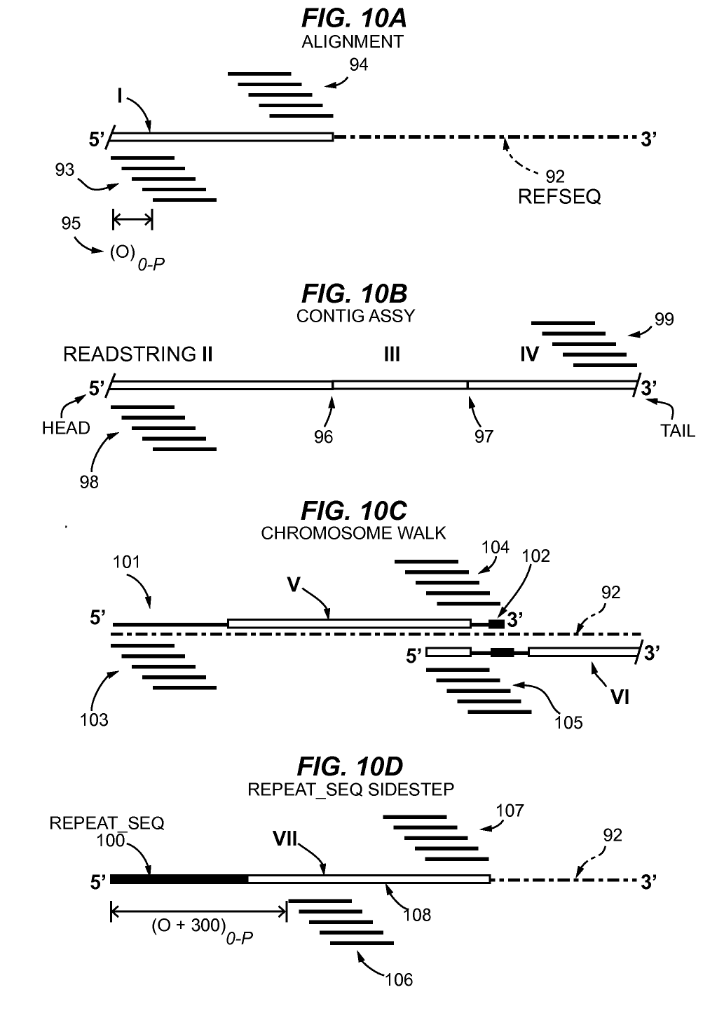

Before detailing a second embodiment of Mercator Matrix transformations, termed here FASTQ.ENDWISE, an overview of a few examples of the use of Mercator transformations in assembling contigs and scaffolds are described. FIG. 10A depicts an alignment of a readstring I on a REFSEQ sequence (dashed line, 92) by use of Mercator Matrix transformations (representing the stepped virtual oligomers (93, 94), where each step is generated according to an OFFSET (95). The effect of OFFSET (0−P) as it slides the readstring I down the reference sequence looking for alignment, is shown figuratively by a series of virtual oligomers offset from zero and stepping a distance of P bases (double arrow) along the reference sequence as defined by the program. This feature also is illustrated graphically in FIG. 6B. Indexing is tracked so that the position of an aligned match may be recorded for future mapping of larger contigs and scaffolds.

FIG. 10B depicts contig assembly as an intermediate end product of an alignment process. These structures are virtual structures, not clones. A first readstring II is an anchor having the 5′ end of the contig (marked with HEAD and TAIL). Readstring II is merged with readstring III at 97, which in turn merges with readstring IV at 98. The intersection set (or “overlap”) of nucleobases common to the joined strands is removed. By returning the contig to the shoebox (for example if a chromosome assignment has not been found in matching with SIGNPOSTS), another round of ALIGN.MATCH may detect matches with other readstrings at either end. Shown are virtual oligomers (98, 99) generated according to OFFSET.

FIG. 10C is a graphical representation of the operation of a Mercator Prism. The figure depicts a step of a virtual chromosome walk using de novo sequence alignment. In this view, the reference sequence has been aligned with a first readstring V, which includes an ORF (open box) and terminal introns (101, 102). The 3′ flanking sequence (102) includes a short intronic sequence (black box) of highly repetitive content that is difficult to map. Virtual offsets have been created, resulting in linked Mercator Matrices, shown here as stepped virtual oligomers (103, 104) Fortuitously, a second readstring VI was also identified from SHOEBOX and has an end-mer sequence that aligns perfectly with one of the offsets 104 of readstring I. Thus the two readstrings may be aligned by either merging the strings themselves according to the offset, or by virtually merging the strings with the reference sequence. To the computer, this makes no difference, and multiple nodal processes can handle this on a first-come-first-serve basis depending on which “bot” gets the problem first. However, given the potential for alternate matches of repeating sequences, the terminal repeat could have been problematic, and the flanking matches with reference sequence 92 eliminate any false branching that could otherwise arise. The dual alignment also strengthens the confidence in a consensus match, and is annotated as an anchor sequence in the resulting contig, along with an index position on the reference sequence, essentially using the reference sequence as a ruler for annotating the contig.

FIG. 10D depicts a “sidestep process” used in aligning sequences identified from a library of repeat sequences such as ALU (the library is termed here: REPEAT_SEQ, i.e., those sequences that are notorious for having multiple copies dispersed in a genome). ALU sequences are typically of the order of 300 bp and are widely dispersed, making up as much as 10% of the human genome. As a supplement to Mercator Prism sequence alignment, Mercator Signature alignment (described in more detail below) may be used to generate a de novo sequence alignment. But an end-match at the 5′ end at 100 (black box indicating repeat sequence) would be problematic because multiple “hits” would be returned from a genomic library. By identifying the signature at the 5′ end as a value associated with a high frequency repeat, a chain process controller may transfer control of the readstring to another processor node or “bot” where OFFSET is modified as (O=300+(0+P)), for example so that the signature is an internal flanking sequence having a uniqueness factor that gets it a match with reference sequence 92. By comparing the offset index at the 5′ end (at 106) and an alignable offset at the 3′ end (at 107), a difference value is obtained that should match the expected size of readstring VII (108) between the offsets. If not, then either a rearrangement, insertion, or deletion has occurred in the specimen (i.e., the specimen is a variant at this locus relative to the reference sequence), there is another better match, or there is an error in the sequencing. In this case, sequence VII includes an ORF, so comparison of the predicted protein with known phenotypes from a protein sequence library may rule out an error. Protein reference libraries include for example the database maintained by the National Center for Biotechnology Information (NCBI). Alternatively, by including multiple layers of coverage and rejecting ambiguities that cannot be resolved, an accurate alignment and assembly can be achieved in a few passes. Genetic linkages may also be informative, as are available in Haplotype databases that are accessible to aid in assembly. As more reference sequences become available, matching can be done by selecting a reference sequence that more closely reflects or highlights the gender, ancestry, parental haplotypes, and any idiotype of the individual specimen, permitting confidence in identifying proper alignment and in identifying previously unreported variants.

As indicated, the Mercator Matrix can be transformed further to support a second kind of matching, which may be referred to as “signaturizing” with a runtime call of FASTQ.ENDWISE. As currently used, this is primarily a means for making first pass quick matches to build up contigs having a high level of uniqueness and match identity, but it may also be used for de novo matching of leftover readstrings after ALIGN.MATCH has completed processing of the SHOEBOX and strings remain that were not aligned. FASTQ.ENDWISE may also be used to validate alignments and to resolve false branches in an assembly tree. When combined with an offset (or a nested truncation of end-mers), a FASTQ Mercator Prism is more computationally intensive, but because each signature is a unique string in a lookup table, the method is both much faster and more comprehensive than other string matching algorithms. Other variants are possible so that the algorithm is not limited to endwise matching, which was chosen for speed in creating a first cut at full assembly with low coverage, and is not intended as a limitation of the process.

FIG. 11A is a flow chart for the FASTQ variant of Mercator Matrix transformation which may be performed by processing logic, as described herein. The process outputs a signature that is used to assemble readstrings into contigs and contigs into chromosomes. The signaturizing process relies on a bitwise convolution of the Mercator Matrix data, and may be used to speed the matching process described in FIG. 5 (54) and to implement DE NOVO alignment of unmatched strings. In some embodiment, the processing logic may create a mathematical signature for each input string.

Illustrated is the FASTQ.ENDWISE process with AGCGGCCGCC, a hypothetical sequence of nucleobases that contains a palindromic Not1 restriction site. Generally, the signature sequence would be longer, perhaps 20, 30 or 35 bases so as to have higher stringency and reduce the number of false branches and loops. But it may be helpful to make some cuts at GC rich sites prior to sequencing rather than completely randomize the fragmentation and/or to inform the sequence alignment with restriction mapping where known.

In this example, the block of ten bases corresponds to an “end-mer” at the HEAD of a readstring. End-mers are useful for fast end-wise matching of strings. The process of bitwise transformation, termed here “signaturizing”, is as follows: In block (110), the processing logic may create a table in the form of the Mercator Matrix. The Mercator Matrix for the ten-mer is represented in the left-hand matrix of panel 116 of FIG. 11B. The same is done for the TAIL end-mer (not shown).

The columns in the table are A, C, G, T and N. The letter N stands for an undefined or undetermined value such as a gap. The non-zero value in any column is the index position of the row of data, and corresponds to the row number, i.e., in each row there is only one non-zero number and that is the row number; its position in the row corresponds to the attribute column to which it belongs. Larger numbers of bases may be included in the matrix for greater stringency of matches and to better treat partial matches—20, 30 or 35 bases may be used for example.

Signaturization may be performed for a series of end-mers over a range. Where a string is k elements in length, for n rows beginning with row 1, herein termed a HEAD, and n rows ending with row k, herein termed a TAIL, the end-blocks of rows are normalized, vectorized and vectors are extracted columnwise as vector rows, and as described below, each vector row may be converted to an integer in a n×4 signature matrix. Thus a set of signatures are obtained, each one representing a truncation of the longest signature obtained. When ranking multiple matches for a single string, the signature match having the largest number of rows is kept, and the others are generally discarded.

In block 111 of the signaturizing process, the elements are normalized by dividing each element of each row by a sum of all elements of the row. All nonzero elements may be replaced with 1's while keeping the order of the rows. In this example, the HEAD and TAIL ends of each readstring are used and will look for fast end-wise matches. The single-bit matrix on the right panel (117) of FIG. 11B represents the full informational content of the sample string above in a normalized and compact form that lends itself to further matrix transformation. By extracting the columns of the matrix above, a set of 5 vectors are obtained:

Vector A: {1,0,0,0,0,0,0,0,0,0}

Vector C: {0,0,1,0,0,1,1,0,1,1}

Vector G: {0,1,0,1,1,0,0,1,0,0}

Vector T: {0,0,0,0,0,0,0,0,0,0}

Vector N: {0,0,0,0,0,0,0,0,0,0}

and they are all the same length. Single-bit digitization of a nucleobase string is believed to not previously have been reported and is an advance in the art. Similarly, vectorization is a novel approach and is advantageously used to simplify and accelerate searching of nucleobase strings.

A similar approach may also be used for searching peptide strings, which may be a concurrent and non-blocking activity of use in recognizing variants, haplotypes, silent mutations, SNPs and indels within ORFs when performed in concert with nucleobase alignment, assembly, and annotation.

In block 112, each vector is extracted (e.g., by transposing the rows and columns of the Mercator Matrix) by the processing logic and then each vector is considered as a representation of a binary number {e0e1e2 . . . ek}, so that each vector string may be converted into a decimal value that is easier to store and analyze. Improved data storage and look-up capability results. So the formula for converting binary values to digital values is:

x=e₀×2₀+e₁×2₁+e₂×2₂+e₃×2₃ . . . +eₖ×2ₖ

More generally, this can be written as:

x=Σᵢ₌₀ⁿ(aᵢ*bᵢ)

where b is any base and a is any integer value to be converted.

Because the value of ‘N’ cannot be analyzed, it may be ignored even if it has a non-zero result. For the above set of vectors, the following transformation results (in base 10):

Vector A=>512

Vector C=>155

Vector G=>356

Vector T=>0

The vector manipulation process is illustrated in FIG. 11C, where the vectors are represented in binary form in four rows of the matrix in upper panel 118 and a signature 119a is shown schematically at the bottom. An ID (120) is used to track the data, as is needed in computer architectures using flat files where indexing is the responsibility of the programmer. The table (includes ID, HEAD_SEQ (121, having four integers HA, HC, HG, HT for each row, and TAIL_SEQ (122, having four integers TA, TC, TG, TT). Two signatures are shown, one for the HEAD_SEQ (119a) and a second for the TAIL_SEQ (119b). The number of rows of the table corresponds to the number of readstrings of the sample. In this way, each readstring can be matched head to tail where there is identity of the signatures. Ten genetic alphabet characters of the initial representation of the fragment sequence are now represented in a matrix transformation as 4 integer numbers. For environments where a numeric value is stored as 32 bits (or 4 bytes), 4 decimals (16 bytes) can store information about a string 32 characters long. The string AGCGGCCGCC is signaturized as {512, 155, 356, 0}. Higher radix expressions may also be used as may be useful for larger P-mers.

Radix compression is useful for larger integers. All computer systems have a limit on the maximum size of numeric values. This limit defines the maximum length of strings that can be represented by the method. The technology stack employed by the system has a numeric value precision of 38 significant digits, and takes 22 bytes to store a vector value. So to store four numbers requires 88 bytes for a 126 character string and this is the longest string that may be stored as vector computations without EOL truncation.

At block 113, the processing logic converts the binary signatures to a signature in a higher radix. By digitizing in Base 10, the full signature for an arbitrary and hypothetical HEAD and TAIL 10-mer is:

{ID1, 512, 155, 356, 0, 142, 1025, 320, 48}

Thus for example in block 114, if a readstring ID1 is compared with a readstring ID201 and the TAIL_SEQ of readstring ID1 is found to be an identity with the HEAD_SEQ of readstring ID201:

{ID1, ID201, [142, 1025, 320, 48], [142, 1025, 320, 48]}

then a reasonable inference is that the two sequences may be contiguous when aligned, as illustrated in FIG. 11D. This is a testable hypothesis, as by ALIGN.MATCH, which may be used to screen the remaining sections of the two strings against a reference sequence.

In this way, readstrings that are partially overlapping with a high level of stringency and/or confidence of a match, may be merged to form a contig (block 115), and to build the contigs into scaffolds, and to join the scaffolds in a sequence output product of the process.

The signaturization of FASTQ.ENDWISE allows for fast data access and extremely fast, efficient data comparisons. A set of four integer values is generated that uniquely “fingerprints” the nucleobase sequence of each tail and head end-mer fragment in SHOEBOX. Signaturization with end-wise matching may be implemented early in the process to pick up any high stringency matches, it may also be employed late in the assembly process to verify the results of the earlier alignments and to pick up matches for left-over strings or where coverage is thinnest. Signaturization also allows for efficient search of repetitive areas within a single chromosome or across multiple specimen samples. Once a library of matching signatures is cached, a processor node can quickly join and identify matching couples—as simply as using a reverse telephone book to look up a name and address. FASTQ.ENDWISE and ALIGN.MATCH are both compact algorithms and may work cooperatively and in non-blocking fashion in a multi-thread processing environment. Because the data is digitized and is a generic data structure, complex calculations may be run in a nodal cluster processing environment having a number of threads sufficient to efficiently multitask sequence alignment and pipeline matches to a master node for assembly under control of a DBMS. Advantageously, this may be done in flat file format without the need for a “De Bruijn plot” and without the need for “k-mer” hashing.

While the discussion has illustrated one embodiment for signaturization of an end-mer, that the signature process may be iterated with an offset. The offset may be either a base-by-base offset (O=0+P) or a “sidestep offset,” where the offset is O=(0+(N+P), where N is a constant, such as 100 or 250, as may be useful in matching signatures of internal flanking regions of a readstring or contig when the end region is identified from REPEAT_SEQ as a sequence that is difficult to match correctly. Increasing the size of the block used to form the signature (by incrementing P) will aid in more stringency of the identity tabulations and a higher accuracy of first-pass correct calls. A shorter P will reduce the size of the matches that are detected, resulting in increased sensitivity and more branching pathways. Thus coverage can sometimes be reduced, in some cases as low as a factor of 5× (to a factor of about 12× for shorter strings and about 5× for longer strings) while increasing speed and at no loss of accuracy. Truncation series of signatures may also be calculated.

The signaturization process described in conjunction with FIG. 11A may be used to generate signatures for a reference model, which may include creating of a unique value for every possible string of length K of the entire reference genome. Similarly, the signaturization process described in conjunction with FIG. 11A may be used for signature assignment of each input string, which are also of length K. In some embodiments, all strings for both the reference mode and the input strings may be the same length for signatures, which may aid in matching the input strings to the reference model. The processing logic may perform a search algorithm to match signature values of all input strings against signature values of all possible reference strings. An example of generating signatures for a reference model and for each input string, and then attempting to match the input string signatures with the reference signatures is provided below.

To generate signatures for the reference model, the processing logic generate a numerical representation of each molecule (A, C, G, T and N [unknown]) in the string for each possible string of K length from the reference genome. The reference genome may include multiple index positions and the processing logic may generate a signature starting at each reference position up to a predetermined length K. For example, the processing logic may begin with index position 1 and may calculate a signature from index position 1+length k. Then, the processing logic may increment the index position by 1 and calculate another signature. For example, the processing logic may calculate a signature for the string starting from index position 2 to position 2+k. Similarly, the processing logic may calculate a signature for index position 3 to 3+k, and so on until a signature is generated starting at each index position. In this manner, the processing logic may create a signature for every possible string of length K from the reference model. The complete set of signatures may be stored in a table of reference signatures. A portion of a table of reference signatures is provided below. For strings of 100 bp length for the Human Genome, this full table may include approximately 3 billion value sets.

| Chromosome | Index Posn | A | C | G | T | N |
|---|---|---|---|---|---|---|
| 11 | 76474585 | 7.5254E+27 | 2.2144E+28 | 1.0399E+30 | 1.9807E+29 | 0 |
| 11 | 76474586 | 1.5051E+28 | 4.4288E+28 | 8.1217E+29 | 3.9615E+29 | 0 |
| 11 | 76474587 | 3.0102E+28 | 8.8576E+28 | 3.5668E+29 | 7.9229E+29 | 0 |
| 11 | 76474588 | 6.0203E+28 | 1.7715E+29 | 7.1336E+29 | 3.1693E+29 | 0 |
| 11 | 76474589 | 1.2041E+29 | 3.5430E+29 | 1.5908E+29 | 6.3387E+29 | 0 |

To generate signatures for input strings, the processing logic may follow similar process described above for generating signatures for the reference model. The input string signatures may be calculated using the same length k as in the reference model. These input string signatures may be stored in another table listing the string identification and the input string signatures for each possible character value.

In an example, as described above, signatures of 1-bit matrices are generated by flipping the row and column structure of a Mercator Matrix so that individual columns are extracted as vectors. As extracted, each column is a binary number and each row corresponds to A, C, G or T, for example. Depending on the location of the leading 1, a symbol is associated with the row: ‘A’, ‘C’, ‘G’ or ‘T’. Consecutive rows therefore produce a String convolution of that array section. The string AGTAC with identity key n¹ then produces the following array:

| A | C | G | T |
|---|---|---|---|
| 1 | 0 | 0 | 0 |
| 0 | 0 | 2 | 0 |
| 0 | 0 | 0 | 3 |
| 4 | 0 | 0 | 0 |
| 0 | 5 | 0 | 0 |

The values of A, C, G and T are then convoluted as described herein, producing a unique signature value. The identity value (n¹) and the signature values are stored in the table of convoluted input strings. An example is provided in the below table.

| Identity | A | C | G | T |
|---|---|---|---|---|
| N¹ | 1.6836E+29 | 3.5773E+29 | 4.8357E+24 | 7.4156E+29 |
| N² | 8.2324E+29 | 4.0350E+28 | 3.1940E+29 | 8.4664E+28 |
| N³ | 8.1256E+29 | 3.2318E+29 | 5.0137E+28 | 8.1782E+28 |
| N⁴ | 9.5569E+29 | 8.9754E+28 | 1.9808E+28 | 2.0240E+29 |

All input strings may be stored in a set of tables, one containing the identifying information of the string, and one containing the actual data values as an indexed set. Reference genomes are stored similarly in a set of tables; one containing chromosomal identification, and one containing the actual data values as an indexed set.

Once signatures are created for each input string, the processing logic may perform a search algorithm which attempts to match signature values of all input strings against signature values of all possible reference signatures. Signatures of the input strings are matched against the indexed signatures of the reference string. If the signature values are equal, the compared strings may be identical. Therefore this results in exact string matches extremely quickly. The result set may be stored in an indexed table showing the input string, the chromosome and the index position of the match.

In some embodiments, a reference string may be signaturized once and stored for later use. In some embodiments, input strings are signaturized for processing, but the signatures are not persistent as once they are matched there may be no further use for the numeric signatures of input strings.

This process may find exact string matches for over 195 million input strings of 100 characters each (e.g., length k=100) in a reference string of 2.38 billion character length within 6 hours.

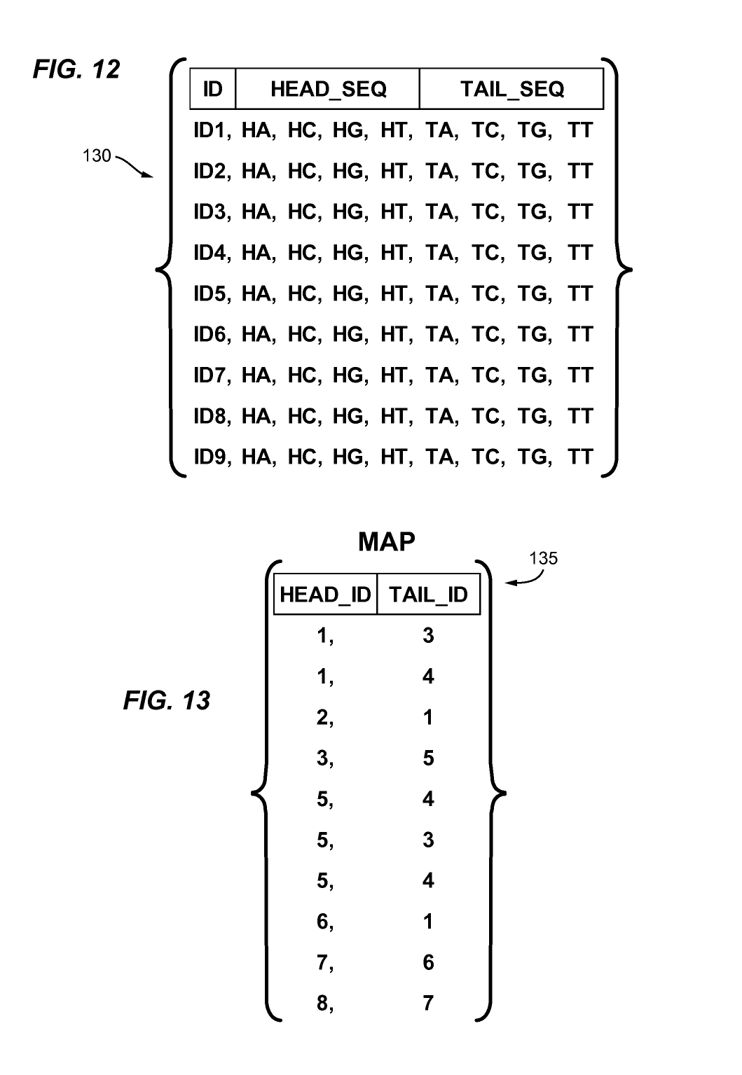

An example description of a contig assembly process based on FASTQ.ENDWISE will now be presented. FIG. 12 is a view of a directory 130 of Mercator Matrix elements as signatures, each row having two signatures, one representing the HEAD_SEQ and the other the TAIL_SEQ of a readstring node. A similar assembly process may be applied to contigs, but for illustration, a collection of nine readstrings (ID1 through ID9) are considered. Each readstring or contig is customarily termed a “node”, each link between nodes is sometimes termed an “arc”, the arc establishing a putative “parent-child” relationship, but no graphical representation is used by the computing system.

FIG. 13 shows an example MAP array 135. The MAP array is a listing of any pairs of matching HEAD and TAIL sequences from the nodes of FIG. 12. Identical signatures indicate a base pairwise match (A for A, C for C, G for G, T for T) and are not indicative of complementarity. Each row of the MAP array is an instance of a node ID having a HEAD_SEQ signature that matches a TAIL_SEQ signature of another node ID. Here for example, the HEAD of node 1 matches the tail of node 3 and also node 4. Branching is not permitted, so the data must be flagged for resolution. Node 2 is unique in that the HEAD signature matches only one tail signature—that of NODE 1—but the HEAD of node 6 also matches the tail of NODE 1 as if branching. Nodes 3 and 5 match so as to seemingly form a loop. The HEADS of nodes 7 and 8 correspond uniquely to the TAILS of nodes 7, 8, and node 8 is an open HEAD, having no matching tail.

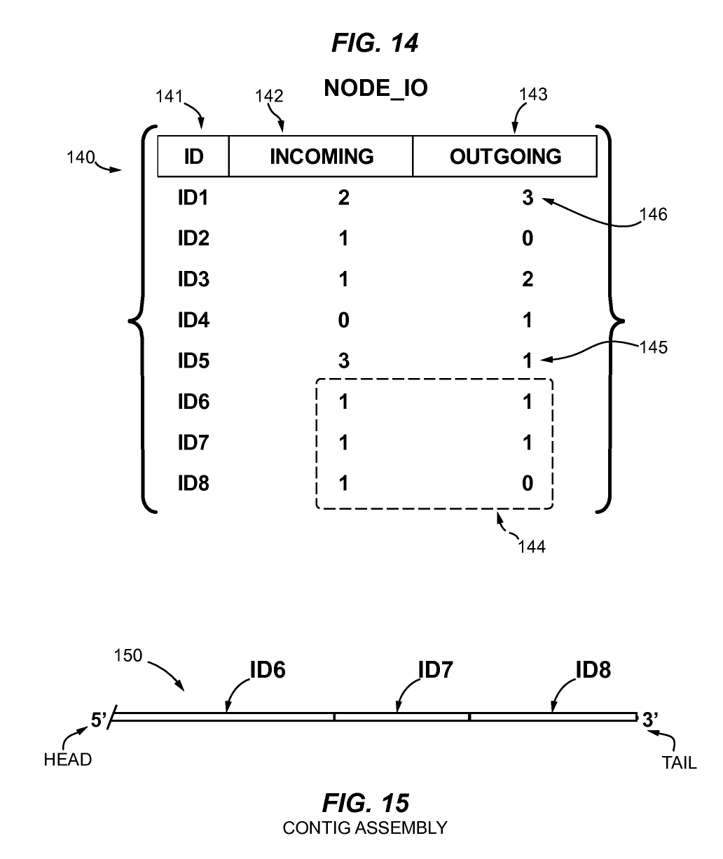

FIG. 14 is a view of an example NODE_IO array 140, listing the number of arcs joining end matches of the nodes of FIG. 13 as indexed by ID (141). Arcs are sorted into INCOMING (142) and OUTGOING (143); where incoming indicates a HEAD connecting to a TAIL and OUTGOING indicates a TAIL connecting to a HEAD. The zeroes in the table would seem to indicate possible initiation or root points for pathways joining readstrings into contigs. The zero for node 8, for example, indicates an open 5′ head, as of a “root node”, and node 8 is joined at the TAIL only to the HEAD of node 7; similarly, the TAIL of node 7 is joined only to the HEAD of node 6. This apparent continuity is indicated by a dashed box 144. Node 5 (145) and node 1 are problematic because virtual branches (endwise links to multiple heads or tails) and loops are not permitted. As noted earlier, node 5 seems to connect with node 3 in a loop. These conditions are rejected. Further confirmation is warranted before concluding that node 2 is a root node and connects at its TAIL to the head of node 1. Based on this data, merge or reject operations may be automatically performed by the computer.

FIG. 15 is a view of a contig assembly 150 deduced from FIG. 13 and FIG. 14. Overlapping sequences are merged (i.e., joined) to form the contig. This map joins root node 8 at the 3′ end with upstream node 7 and terminates at the 5′ end with node 6. Any mapping instance may be preliminary, and is confirmable by added levels of coverage or by alignment on a reference sequence. Because all these verifications are carried out concomitantly, nested iterations of mapping and assembly achieve a high level of confidence in the output.

Contigs may be joined to larger chromosomal fragments by a similar endwise alignment and assembly process. Thus assembly is a bottom-up process of assembling smaller fragments, generally from random fragmentation, shotgun cloning or polony, into larger contigs, and assembling contigs into scaffolds, and assembling scaffolds into chromosomes. Advantageously, by structuring memory registers to hold Mercator data structures of the invention, an entire chromosome can be held and processed in memory registers so as to improve system performance.

Complementary sequence information is not discarded. Matches in both the 5′ to 3′ orientation on the Watson strand and the Crick strand are detected by signature identity, where signaturizing has been performed by normalization, vectorization and radix transformation as described above.

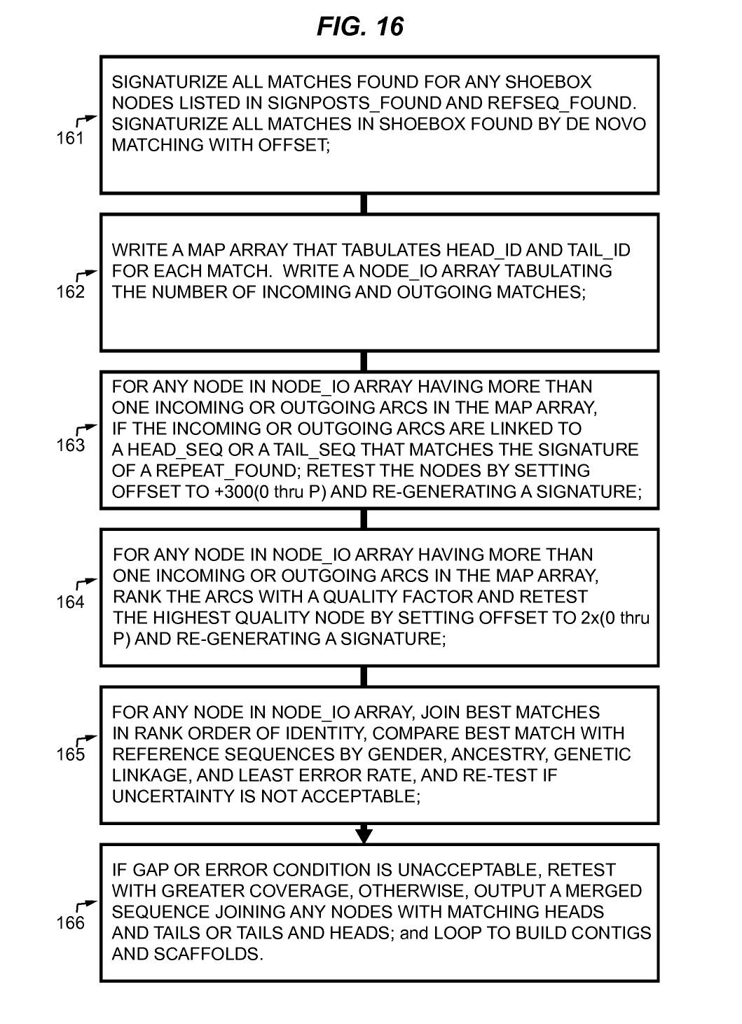

FIG. 16 is a schematic describing steps of an alignment and assembly operation which may be performed by processing logic as described herein. In block 161, the processing logic may signaturize all matches found for any unique SHOEBOX nodes in SIGNPOSTS_FOUND (FIG. 5, 52) and REFSEQ_FOUND (FIG. 5, 53). The processing logic may also tabulate signatures found for matches by DE NOVO matching with offset (FIG. 5, 54). Signatures may be written for heads and tails of each of the Mercator matrices corresponding to a sequence fragment.

In block 162, the processing logic may write a MAP array that tabulates HEAD_ID and TAIL_ID for each match, where the data take the form of (x,y) pairs and each head and tail are associated with a particular string from SHOEBOX, SIGNPOST, OR REFSEQ. The processing logic may write a NODE_IO array tabulating the number of incoming and outgoing matches. Nodes having multiple incoming or outgoing matches may have false branches. The processing logic may filter out any loops and test for false branches. For any node in NODE_IO array having more than one incoming or outgoing arc in the MAP array, if the incoming or outgoing arcs are linked to a HEAD_SEQ or a TAIL_SEQ that matches a REPEAT_SEQ found in the repeat sequence library, the processing logic may retest the node match by setting an offset to reach into an internal flanking sequence of the string and regenerate a signature (163). For any node in NODE_IO array having more than one incoming or outgoing arc in the MAP array (164), the processing logic may rank the arcs according to a quality factor and retest the highest quality node pair by setting offset to 2×(0−P) and regenerate a new signature for comparison; and discard nodal identities if the signatures do not match. For any node in NODE_IO array, join the best matches in rank order of identity (165), the processing logic may compare best matches with reference sequence library members by gender, ancestry, genetic linkage literature, and least error rate, and re-test with higher coverage if uncertainty is not acceptable. And if any gap or error condition results in an unacceptable confidence factor, the processing logic may retest with greater coverage; otherwise, the processing logic may output a merged sequence joining any nodes with matching heads and tails or tails and heads (166). The processing logic may continue to loop through the process to build contigs and scaffolds.

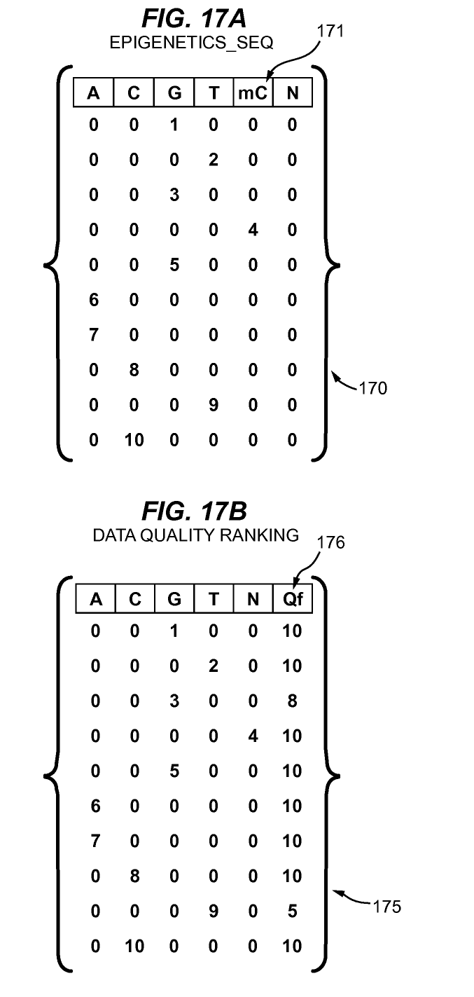

FIG. 17A is an example Mercator Matrix 170 having an expanded number of columns to include an epigenetic attribute termed “mC” (171). Methylation at cytidylate residues (forming 5-methyl-cytosine, “mC”) was the first of several base modifications that have been detected and affects gene expression. Advantageously, the Mercator transformations of the invention are readily adapted to increasing complexities of genetic information, such as the wave of epigenetic mapping that will become available in the next decades. The data model accommodates capturing and processing of additional data elements such as an epigenetic modification field, and a read quality indicator field. These new fields can be added as columns after column N. To handle RNA, Uracil residues may be plotted in a separate column of a horizontally expanded matrix, or may automatically be converted to Thymidylate residues as in cDNA with an annotation that the specimen is an mRNA or was derived from a cDNA library.

FIG. 17B is an example Mercator Matrix 175 including a column 176 for quality score (Qf) annotations. For example, quality indicator Qf will have a value representing read accuracy for a particular symbol at its location. It is inherent in bottom-up sequencing that false branching will be encountered and a cumulative uncertainty will exist during assembly. The data structure is capable of retaining annotations on the quality of base calls, including also gaps. Qf is factored into probabilistic assessments of the tree structures that accumulate as provisional assembly. The Qf factor may be a non-integer fraction or a percent for example. Assemblies can be weighted to discount mismatches and gaps, or can be flagged for further confirmation when an individual-specific variant is suspected, such as a variant, a SNP, an indel, or a rearrangement. The use of quality factors relates to earlier approaches used in PHRED and PHRAP, but is shown here to be compactly associated within the Mercator data structures, eliminating the need for separate indexing or additional tables, and complements the use of “N” for gaps in the sequence as are commonly found in shorter read, polony-derived sequences and from GC rich areas.

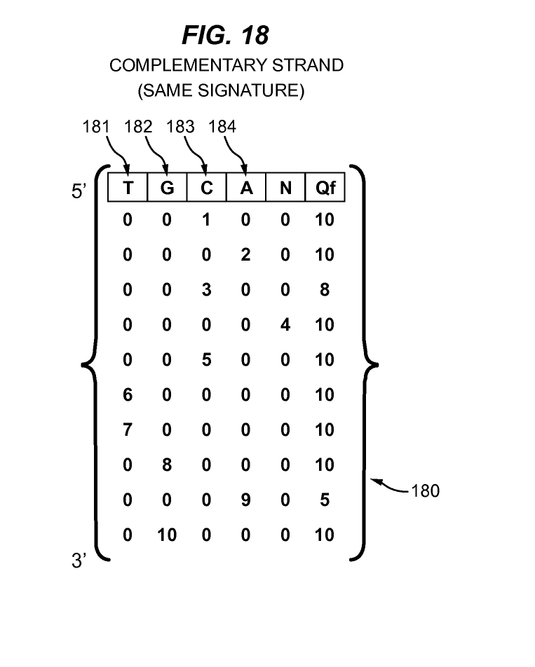

FIG. 18 is an exemplary Mercator Matrix 180 in which the attributes (181, 182, 183, 184) are transposed as for a complementary strand sequence, while retaining a common 5′-3′ reading frame so that Mercator signatures are identical for both a Watson readstring and a Crick readstring. As shown, the signature of the transposed matrix is identical to the signature of FIG. 17B and would thus be matched for possible alignment. During the alignment process, the complementary strand would be read so that it can be merged in proper orientation with a 5′-3′ reference strand according to the accepted standards for reporting sequences.

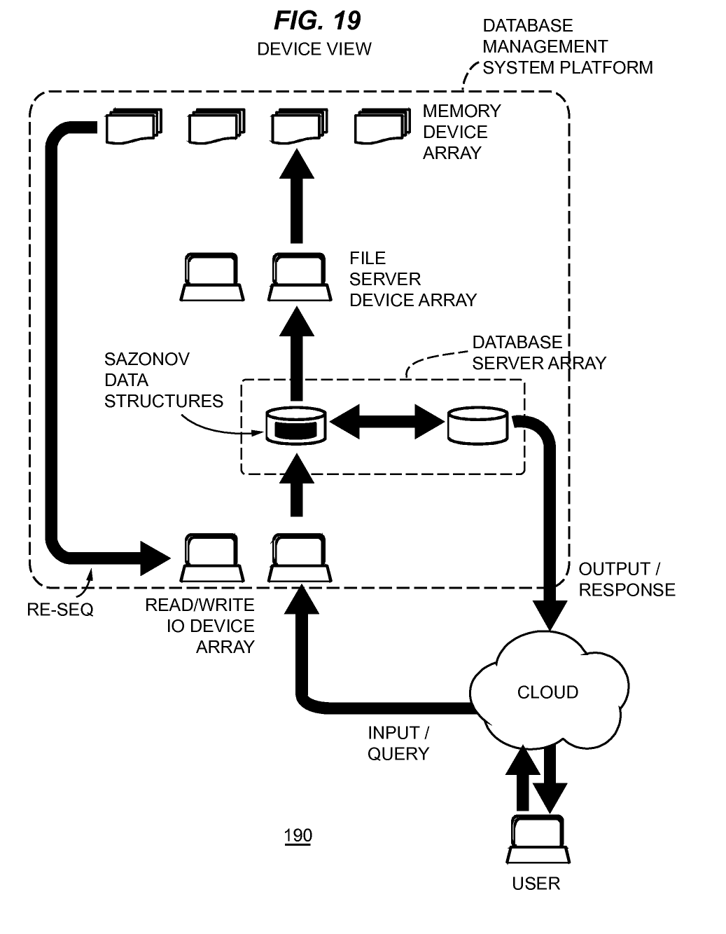

FIG. 19 is a view of a computing machine 190 that embodies technical features of the inventive data structures for sequence alignment, assembly, matching and comparative genetics. Shown is schematic view of a processing system using a plurality of database processors in a DBMS platform. Mercator tables define tasks that can be parallelized concurrently on nodal processes and are structured so that each processor may share files, data in memory, and task status updates. Under the DBMS platform, each database is a computer cluster that may contain a plurality of processor nodes that operate as nodal clusters, splitting tasks by type or by quantity. When the thread capacity of an individual node is exceeded, new nodes can be recruited. Also shown are Read/Write devices and file sharing devices that provide I/O functions and manage memory read and storage tasks. The memory array (top) becomes an input for the database server array (bottom), so that the system continues to expand its capacity to compare genetic sequences with reference sequences in memory, and thus improve the confidence factor for re-sequence alignments.

At least one database server includes Mercator data structures in cache memory. Mercator Matrices are stored in memory and are used in calculations based on the prism operations described in FIG. 8 and FIG. 9. Dedicated cache memory registers also may be used for the Mercator data structures, such as for reference sequence and signpost libraries stored as Mercator Matrices. These database structures have the effect of defining a nodal computing workflow and computer structure in which memory and processors are assigned according to the size and structure of the Mercator tables.

The processing is not serial or batchwise, and includes a higher level of parallel task sharing between processor nodes that is termed “clustering”. In addition, each processor may initiate multiple threads on which processes may be executed. The number of active processing centers is equal to the sum of the number of active threads at each of the processor nodes for each of the database servers (referred here as “DB”), and may vary with the workload. Typically each processor is provided with large cache memory, some of which is dedicated, and other memory caches that are shared. Memory is used for transitory and persistent data storage and also for compiling machine instructions (e.g. for supplying instructions to a processor node or an array of processor nodes).

The DBMS platform may be referred to as the computing machine comprising the database servers (with processors), associated memory and libraries, and I/O devices. Each database server may have 1, 2, 4, 8, 12 or more processors and each processor may have a plurality of process nodes, all sharing tasks, outputs and task status updates under control of a database management system registry and architecture.

FIGS. 20A-20B are a composite of views of a computing machine or DBMS platform embodying heuristic features of the inventive database management systems and programming as configured for nucleobase sequence alignment, assembly, matching and comparative genetics.

Shown is a schematic view of an expanding parallel processing environment using a plurality of database processors linked by a DBMS that promotes memory sharing between processors so that each processor may share files, data and task status information. At any point, the scope of the computational task determines the dimensions of the processor, read server, and IO device arrays that are engaged in the process, which proceeds with multiple threads, where threads can share data on the fly (“streamed”) without segmentation by batch tasking.

Mercator table functions make this possible. A table function can take a collection of rows as input. A row may be structured, for example, as a Mercator Prism as shown in FIGS. 7A and 7B and thus the table can be processed in massively parallel node clusters. Execution of table functions is parallelized over table structures; returned rows may be streamed directly to a next process node without intermediate staging or batchwise processing. In one implementation, rows returned by a table function (such as SELECT) can be “pipelined” (in other words, iteratively returned as the rows are completed instead of tablewise all at once in a batch) so as to reduce the memory that the table function or bot requires, because the object cache does not need to materialize the entire nucleobase sequence in order to process a single row or signature of a Mercator Prism or matrix. Streaming, pipelining and parallel execution of Mercator table functions improves performance by enabling multi-threaded, concurrent execution of table functions in clusters, but eliminating intermediate staging between processes, and thus improving query response time.

Thus the processing is not serial; the process can be described as meta-looped, and includes a higher level of cross-parallel task sharing between processors that is sometimes termed “clustering”. In addition, each processor may have several clustered processor nodes at which processes may be executed. The number of active processing centers is equal to the sum of the number of active processor nodes at each of the database servers (referred here as “DB”), and may vary with the workload. Typically each processor is provided with large cache memory, some of which is dedicated, and other memory caches that are shared.

In a first loop, marked here as “A”, a single I/O reader 219a pushes input (218a) and/or queries to a database server 220a. The server includes at least one application program specifying a sequence alignment and assembly computation, a relational database for storing data that participates in the calculation, and may include a programming interface registry and LAN or SAN for distributing and coordinating data and instructions between program nodes. Arguments to a running program are passed in a non-blocking fashion and are parsed and validated without waiting for a full set of results from other programs that are operating in parallel. Each node maintains a pool of threads and tracks status (free, busy) but can create additional threads to meet demand within the limits of the hardware. A constellation of bots may be generated to serve each node and manage the execution of program fragments on behalf of the database server. Associated data and address buses for parallel data transfer, and any bussed interconnections, are not shown for clarity of concept.

Write output is managed by an output IO server 221a and data is transferred to persistent memory libraries 222a. Schematically, in a second loop “B”, additional library data space 222b is needed. The libraries contain reference sequences that may be accessed to accelerate sequencing of new specimens 218b. Additional database servers 220b are installed or recruited as needed for the greater demand. Added IO capacity 221b also is added.

In a third loop, representing a more mature system, multiple resources are arrayed. The I/O reader complex 219c is represented by three machines; six data servers (220a-f) are represented, and five output IO servers 221a-e are ported to persistent memory 222c, which is represented as containing multiple reference sequences as well as client assemblies. The system is capable of accepting multiple inputs (218c) for simultaneous assembly.

The quantity of memory available for storing sequence libraries may be 4 Exabytes and may be expanded beyond 64 Exabytes by adding library servers to the cluster. Generally this memory is solid state memory (providing faster read/write operations). Also accessible are internal RAM caches having on the order of 256 GB per processor.

The computer architecture may assume a helical structure when represented as a two dimensional ribbon of interconnected libraries, read/write devices, and DBMS core servers.

The ribbon may be an apt description in realizing a computing structure that will grow by lateral expansion of database and memory arrays as additional annotated sequence libraries become available and are built in house. Thus the computing architecture and system is infinitely scalable. Dynamically accessible memory of 64 Exabytes is a “first cut” estimate of the sequence information that can be assembled in the next 10 years from string reads and contigs generated in the course of environmental, veterinary and medical research, and is readily achievable with this system.

As a result, a robust, scalable, system is attained for performing sequence alignment and assembly and is easy to use. The system learns with each task successfully completed and will grow in size and accelerate in processing speed as more reference sequences are generated.

Thus the system achieves synergy in that the whole becomes more powerful than the individual parts, and achieves emergent properties in that the rate of sequence assembly becomes faster as the system increases in complexity and the system achieves a capacity to create reference databases of genomic information on a planetary scale, having the capacity to predict answers to questions about how communities and environments interact and make predictions about how they respond to disruptions, such as ocean fertilization, effect of climate change on food webs, introduction of invasive species, and so forth. Also contemplated is use of sequence data to tailor therapies and to improve outcomes to treatments, particularly as larger annotated datasets become available. An estimate that 64 Exabytes of memory will be accessible to queries by this stage of the process, and that is sufficient memory to store the genome of every human on Earth, making personalized medicine a universal reality. Alternatively or in parallel, vast collections of organisms can be sequenced so that the metabolic and niche density webs of every ecosystem on the planet can be constructed from the metadata inherent in the sequence tables. Because these tables are stored as Mercator data structures, queries manipulating character-large-objects will be possible and can be rapidly processed in background with other ongoing tasks. In handling biomedical data, encryption is standard, as described in FIG. 21, and queries may be directed to information sets that have been stripped of personal identifiers, or to personal sequence information on presentation of unhackable bona fides.

Systems that implement the present invention are not limited to any particular type of memory or to any particular database architecture. However, these are clustered computing systems and the volume management and file system used for storing database data are “cluster aware”. Databases having cache memory and multiprocessor clusters or combinations capable of sharing cache memory may be used. Mercator data structures are generic throughout the database, simplifying programming.

In one embodiment, processes are typically divided between a plurality of processors, each processor having a plurality of nodes, each node running one or more scripts. The term “scripting” is used broadly to indicate a variety of embedded logic operations characteristic of DBMS, and languages in which scripts may be written (or are provided with the operating system) include SQL, PERL, JAVA, C++, and PYTHON, while not limited thereto.

A detail of database functionality is shown in FIG. 20C, which is a schematic view of multitasking in a polynodal computing environment (250) having two linked databases under control of a DBMS platform, as seen in the context of the larger system of FIGS. 20A-20B. For this exemplary system, each database (200e, 200f) is assumed to have 126 GB of internal cache memory and a line character read-write length of about 32,000 characters per line, although, less optimally, systems having line lengths of only about 2000 or about 255 character strings may also be operated by reconfiguring table sizes.

Sequence computations are divided by the DBMS between multiple nodes and may be segregated in different database devices (200e, 200f). The nodes in the database technology stack may concurrently run separate processes, as indicated here by the bubble captions, where each subprocess is a fragment of the table-wise, row-wise, or column-wise structural organization of tasks. Nodes may also coordinate autonomous processes that work in parallel on larger tasks. One node for example may have a task of unpacking SIGNPOST strings row by row and comparing each row to all the rows of strings in SHOEBOX. But the node may also designate hundreds or thousands of autonomous bots to do the task, each bot having a copy of the program instruction or fragment, each bot engaging a thread that receives one SIGNPOST sequence as a Mercator Matrix and a portion of the table of readstrings in SHOEBOX. Advantageously, the table is indexed and the subtables all share the same attributes, so the bot may operate with minimal memory resources and may simply pull one row at a time rather than manifesting the entire SHOEBOX table in its memory. While one bot is working on some of the rows from SHOEBOX, another bot is working on other rows. In this way the entire shoebox can be divided into subtables that are assigned to as many bots as are needed to screen the strings in the rows for a match with a signpost string in seconds. Once this is completed, the process can resume by reading a new signpost string.

Accelerated searching may also be used. Each string in a Mercator table may be signaturized and presented to an army of bots as a table of signatures for matching to a table of signpost signatures.

In the example shown, a table having a Mercator Prism structure, with two strings to be compared and an offset can be handled simply by creating a family of Mercator Matrices, each corresponding to an offset, under autonomous control of a “bot” (251). The program fragment tabulates the matrix of offsets for each readstring accessed from the SHOEBOX and can output each matrix on the fly to a second bot, not waiting to process the remainder of the input table, which may be referred to as “streaming”. Thus a second bot (252) can be designated to receive the output matrix and process it as fast as it is received. The second bot for example can normalize, vectorize, and convert integer values to a higher radix, outputting a table to a third bot (253). The third bot may have in memory a program fragment and read arguments from the table from the second bot so as to create tables MAP and NODE_IO (as were discussed with reference to FIGS. 13 and 14); tabulating endwise matches. From these tables, and following a few simple logic commands on the table sets in memory, formation of contigs, scaffolds, chromosomes, exomes and genomes may be performed. The contigs may then be placed in the shoebox with unmatched readstrings and the process can continue cyclically. A combination of searching by signpost, reference string, and de novo searching will yield identical matches first, and then may be repeated with reduced stringency or higher coverage in order to form scaffolds and re-sequence the exome, for example, allowing for variants, until no further matches can be verified.

Data that is complete (255) may be output at a RETURN command (254) and thread output may be pipelined. Data that is incomplete (256) may be returned to a SHOEBOX for further rounds of loopwise alignment that proceeds from easy to harder.

Mercator data structures facilitate the execution of code for long character strings by transformation of the genetic alphabet into a numerical equivalent. Nonetheless, Mercator tables may be very long character strings. In a Linux or Unix OS, a line return is inserted at 255 characters when data is written to a file. Advantageously, in ORACLE® 12C RAC systems (ORACLE, Redwood City Calif.), the character limit may be up to 32,767 characters per line in a VARCHAR element, and may contain up to 4 Gb of data in a single Character Larger OBject (CLOB) data element, long enough to put the equivalent of an entire genome on a single line in a table. CLOB elements may be treated as any other string in an Oracle RDBMS. Thus the Mercator Matrix (as a flat file) becomes a very powerful and compact way to organize instruction sets on large data arrays and to subdivide complex sequencing assembly operations into discrete functional units that can be run in a “streaming parallel processing environment”, where each completed row is transmitted to the next functional subprocess while the operation continues to advance through the remaining rows or columns of input. This capacity to work in a multi-stage processor environment without the limits of batch mode results in a dramatic increase in speed and is a direct result of the simple tabular structure of the Mercator Matrices. As described in FIG. 5, multiple kinds of matching and alignment processes may occur (52, 53, 54), offering further opportunities for parallel processing in non-blocking multi-processor operations that may share memory. The degree of parallelism and the number of threads is expansible and under control of a chain or cluster controller or a daemon that assesses workload and creates resources accordingly, within the limits of the system build, which are expansible as shown in FIG. 20B.

FIG. 21 is a view of an encrypted library of genomic reference sequences 310 derived from the inventive data management system and Mercator data structures. An API (311) is used in a database server to provide cloud-based access to the data for multiple researchers or users 312. “Anonymous Key Technology” or AKT encryption with a high level of security is used to transmit data and to store data internally. Some details of encryption are described in U.S. Pat. No. 6,941,454 which is herein incorporated in full by reference.

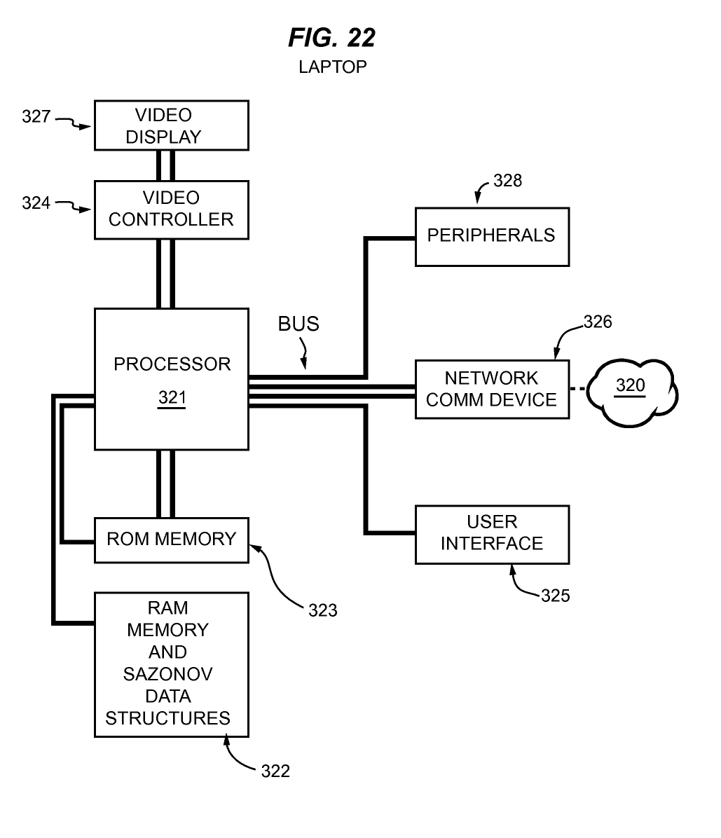

FIG. 22 depicts a computer having program instructions and memory resources for executing sequencing software having Mercator data structures. In this embodiment of a sequence assembler/analyzer, the software may be run on a single processor having the features shown, such as a Pentium series processor (Intel, Santa Clara Calif.). The computing machine has features of a desktop or a laptop computer and is intended primarily for a single user. These machines frequently are digitally linked to a cloud network 320 such as the internet, and may share data and processes in discrete serial and parallel operations. The figure provides a general architectural diagram for various types of computers and processor-controlled devices configured to read and manipulate Mercator data structures, including laptops for example. This high-level architectural diagram describes a processor-controlled system on which the currently described Mercator processes, sequence assembly and analyses are executed. The computer system contains one (or multiple) processor(s) 321, one or more memory devices, including dynamic 322 and read-only 323 memories interconnected with the processor(s) by a bus or multiple busses, and digital bridges or connections with additional busses or other types of high-speed connections, including serial interconnects as needed. These busses are generally interconnected to multiple controllers, such as a video controller 324, a user interface port 325, and a network interface controller 326, and access electronic displays 327, input devices 328, and other such components, subcomponents, and computational resources.

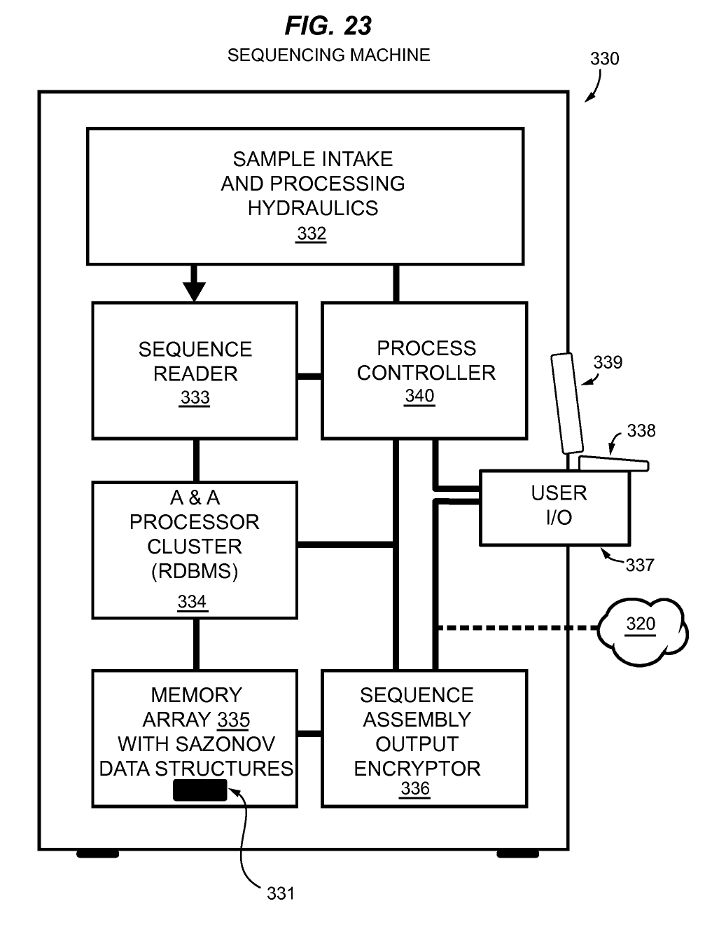

FIG. 23 is a block diagram of a sequencing machine 330 of the invention that incorporates on-board data processing utilizing the Mercator database structures 331 and programming of the invention. Input for assembly is acquired on board through what is generally a wet chemical process that involves sampling, at least endstage sample preparation and labelling, and reading, where reading is a process for determining the order of nucleobases in at least one nucleic acid polymer in the sample. Raw sequence data may be obtained by methods known in the art. Sequence readers using Sanger method based sequencing include those supplied by Illumina, 454 Life Sciences, Visigen, Pacific Biosystems, while not limited thereto. Others such as Oxford Nanopore, Northshore Bio, IonTorrent, Quantum Bio, Mercator BioLogic, and others are developing various optoelectric, direct read sequencing methods. These technologies rely on recent advances in uses of fluorescent base analogues, fluorescence detection, dye-labelled terminators, pyrophosphate enzymology, genetically engineered polymerases, gel electrophoresis, capillary gel electrophoresis, nanopore-based transducers, and microfluidics, while not limited thereto.

In brief, the sequencing machine is a system having a mechanical, hydraulic and/or pneumo-hydraulic system for manipulation of nucleic acid polymers 332, a sequence reader system 333 for detecting and differentiating nucleobases in order of polymerization or depolymerization (or as detected by physical or electrical characteristics of the polymer as it passes through a nanopore), and a processor cluster with RDBMS 334 for collecting data in digital form, where the option to collect the data as strings of ACGT is supplemented or replaced by database collection and management systems operating on, storing, analyzing and/or outputting data as Mercator Matrices 331 in memory 335 or transmitting encrypted output (336), such as via a network connection 320 shown here schematically as a cloud-based network for example. Systems may also include a user interface 337 with keypad 338 and screen 339. In advanced builds, some functions of the computing cluster may be executed in firmware (not shown).

Machines of this class generally include at least one controller 340 for synchronizing the process of sample intake, fluid control, power, switching reagents, watchdogging of circuitry, and so forth. The machines may process tens of thousands of bases per second and, in consequence, a processor cluster 334 is needed to align, assemble and annotate the sequence at an equivalent rate to avoid storage of overflow data. In some embodiments, the machines may process read rates exceeding 10 thousand bases per second, per channel on the device, with up to 1200 channels per device which may include reading 12,000,000 bases per second. For re-sequencing, the database manager is configured to manipulate and store Mercator data structures that enable rapid comparison of nascent raw sequences with a library of reference sequences, any one of which may occupy 6 GB of memory or more. In an estimate, a reference library of 96 whole genome sequences is appropriate for the human species and advantageous for most re-sequencing, indicating that about 600 GB of data could be indexed and searched during initial matching if gender and ancestry is not assumed. Advantageously, the Mercator process is demonstrated to be faster than competing methods of sequencing and alignment and can reduce the on-board computer resources needed for a stand-up sequencing machine of FIG. 23. An example is illustrated in the table below:

| | |
|---|---|
| Human genome | 3,280,000,000 |
| # pairs read per second | 10,000 |
| # pores per chip | 1,200 |
| # total pairs read per second | 12,000,000 |
| Seconds to read full genome | 273 |
| Minutes to read full genome | 4.56 |

### EXAMPLES

### Example 1

An initial speed test was conducted using a single processor operating a serial process for “re-sequencing” of 100 bp fragments derived by a process of in silico fragmentation from the Chromosome 6 exome sequence. The reference sequence includes 171 Mbp, contains known 2302 genes, and includes three contigs (NT_{—}007592.16; NT_{—}187199.1, and NT_{—}025741.16). The sequence (http://www.ncbi.nlm.nih.gov/projects/mapview/maps.cgi?taxid=9606&amp;chr=6, accessed 2014) was downloaded from NCBI.

Chromosome 6 is of interest in part because 34 UniGene clusters have been recognized. However, seven large alternate loci have been identified in the major histocompatibility complex (MHC) region, including haplotypes APD, COX, DBB, MANN, MCF, QBL, SSTO, and there is significant CpG island content and other repeat sequences. The sequence is not complete and may contain patches. The reference assemblies were created by a best placement alignment of BAC sequences (at a cutoff of <90% identity) obtained by a combination of hierarchical and shotgun sequencing and were aligned based on a combination of homology for protein and cDNA open reading frames and ab initio modelling. Gaps and errors exist in the reference sequences. Re-sequence alignment and assembly (using integrated Mercator Prism and signature database structures in a sequence assembly software package) achieved a full assembly in about 16 hours with minimal resources (i.e., on a single processor operating with single threaded serial instructions).

### Example 2

Using a Linux server with cache memory and cache storage running on software designed around the Mercator data management process, a SHOEBOX full of artificial read fragments was matched and aligned to exome-derived SIGNPOST sequences in about 1 hr and 15 min.

### Example 3

In another test of Chromosome 6 assembly from artificially fragmented read-strings, Mercator software for the trial was first compiled on Linux server with cache memory and cache storage. Processors were clustered for modified parallel processing under DBMS control of a chain controller. Exome assemblies using 50, 100 and 200 “bots” to run a Mercator process with 5× coverage were demonstrated on a single head processor.

### Example 4

Read strings from a sequence reader are input into a computing machine of the invention. Reads are about 1 kb in length on average. The computing machine operates with twelve nodal processors and 4 Exabytes of cache memory on software of the invention and includes 2 human reference sequences. A whole human exome is re-sequenced and validated in under about 35 minutes and the full genome is re-sequenced in under 6 hours.

### Example 5

Raw sequencing readstrings are input into a computing machine of the invention, the computing machine operating on software of the invention. A whole human genome sequence is assembled validated, and delivered in less than 48 hrs.

### Example 6

A system for digitally receiving a set of nucleic acid sequence fragments collectively derived by a process of sequencing a specimen, and assembling the set of sequence fragments into longer contiguous reads according to matches with a reference sequence or subsequence, which comprises: a computing machine having a cluster of processors, compilable program instructions, and shared cache memory, wherein said program instructions when executed by said cluster of processors operate to: define a data structure wherein any string of nucleobases is digitally expressed with embedded natural order in a matrix having k rows by four columns, where k is the number of nucleobases in said string and each column attribute corresponds to a nucleobase residue by type, said matrix constituting a Mercator data structure; construct an indexed table of said data structures for all sequence fragments to be matched, and for every row of said table, construct offset data structures having an offset alignment according to a range of offset values; and, make a row-by-row search for matching alignments between any offset data structure of a sequence fragment and any data structure or structures of a reference sequence or subsequence; and iteratively merge any two sequence fragments having an overlap of an end sequence when matchingly aligned until no further matches are found.

The system described above, wherein said data structure is further characterized in that each indexed row has only one non-zero integer value and said non-zero integer value advances from 1 to k in said rows of said matrix, thereby embedding said natural order.

The system described above, wherein said data structure includes another column corresponding to a null or unidentifiable nucleobase attribute, such as may be used for ranking fuzzy alignments and assemblies.

The system described above, wherein said data structure includes another column corresponding to a reliability factor indicative of a quality of a base call, such as may be used for ranking fuzzy alignments and assemblies.

The system described above, wherein said reference subsequence is a signpost.

The system described above 1, wherein said reference sequence is an exome, a chromosome, or a genome.

The system described above, wherein said specimen is a human specimen, and animal specimen, a plant specimen, an insect specimen, or a specimen derived from a prokaryote, an archaebacteria, or an eukaryote.

### Example 7

A system for digitally receiving a set of nucleic acid sequence fragments collectively derived by a process of sequencing a specimen, and assembling the set of sequence fragments into longer contiguous reads according to endwise matches between sequence fragments, which comprises: a computing machine having a cluster of processors, compilable program instructions, and shared cache memory, wherein said program instructions when executed by said cluster of processors operate to: define a data structure wherein any string of nucleobases is digitally expressed with embedded natural order in a matrix having k rows by four columns, where k is the number of nucleobases in said string and each column attribute corresponds to a nucleobase residue by type, said matrix constituting a Mercator data structure; for each data structure normalize said matrix to binary strings, each row of said matrix having only one non-zero value, then for n rows beginning with row 1, herein termed a head, and n rows ending with row k, herein termed a tail, vectorize and extract vectors columnwise from said matrix as vector rows, and convert each to an integer in a n×4 signature matrix; construct an indexed table of said signature matrices for all sequence fragments to be matched end-to-end, make a row-by-row search for matching between any heads and tails or tails and heads but of multiple matching instances for a single data structure, select only the instance having the greatest k; and, iteratively merge any two sequence fragments having matching heads and tails until no further matches are found.

The system described above, wherein said data structure is further characterized in that each indexed row has only one non-zero integer value and said non-zero integer value advances from 1 to k in said rows of said matrix, thereby embedding said natural order.

The system described above, wherein said data structure includes another column corresponding to a reliability factor indicative of a quality of a base call, such as may be used for ranking fuzzy matches and assemblies.

The system described above, wherein said specimen is a human specimen, and animal specimen, a plant specimen, an insect specimen, or a specimen derived from a prokaryote, an archaebacteria, or an eukaryote.

### Example 8

A product-by-process, which comprises, a nucleic acid sequence assembled from sequence fragments by a process of providing a computing machine having a cluster of processors, compilable program instructions, and shared cache memory, wherein said program instructions when executed by said cluster of processors operate to: define a data structure wherein any string of nucleobases is digitally expressed with embedded natural order in a matrix having k rows by four columns, where k is the number of nucleobases in said string and each column attribute corresponds to a nucleobase residue by type, said matrix constituting a Mercator data structure; construct an indexed table of said data structures for all sequence fragments to be matched, and for every row of said table, construct offset data structures having an offset alignment according to a range of offset values; make a row-by-row search for matching alignments between any offset data structure of a sequence fragment and any data structure or structures of a reference sequence or subsequence; and iteratively merge any two sequence fragments having an overlap of an end sequence when matchingly aligned until no further matches are found.

The product-by-process described above 1, wherein said data structure is further characterized in that each indexed row has only one non-zero integer value and said non-zero integer value advances from 1 to k in said rows of said matrix, thereby embedding said natural order.

The product-by-process described above, wherein said data structure includes another column corresponding to a null or unidentifiable nucleobase attribute, such as may be used for ranking fuzzy alignments and assemblies.

The product-by-process described above, wherein said data structure includes another column corresponding to a reliability factor indicative of a quality of a base call, such as may be used for ranking fuzzy alignments and assemblies.

The product-by-process described above, wherein said reference subsequence is a signpost as described herein.

The product-by-process described above, wherein said reference sequence is an exome, a chromosome, or a genome.

The product-by-process described above, wherein said product is an exome sequence assembly, a chromosome sequence assembly, or a genome sequence assembly.

The product-by-process described above, wherein said product is a human exome sequence assembly, a human chromosome sequence assembly or a human genome sequence assembly.

The product-by-process described above, further comprising annotations.

The product-by-process described above, said product defining a reference sequence specific for gender, ethnicity or ancestry.

### Example 9

A product-by-process, which comprises, a nucleic acid sequence assembled from a set of sequence fragments by a process of providing a computing machine having a cluster of processors, compilable program instructions, and shared cache memory, wherein said program instructions when executed by said cluster of processors operate to: receive a set of sequence fragments, each sequence fragment defining a string of nucleobases; define a data structure wherein any string of nucleobases is digitally expressed with embedded natural order in a matrix having k rows by four columns, where k is the number of nucleobases in said string and each column attribute corresponds to a nucleobase residue by type, said matrix constituting a Mercator data structure; for each data structure normalize said matrix of binary strings, each row of said matrix having only one non-zero value, then for n rows beginning with row 1, herein termed a head, and n rows ending with row k, herein termed a tail, vectorize and extract vectors columnwise from said matrix as vector rows, and convert each to an integer in a n×4 signature matrix; construct an indexed table of said signature matrices for all sequence fragments to be matched end-to-end, make a row-by-row search for matching between any heads and tails or tails and heads but of multiple matching instances for a single data structure, select only the instance having the greatest k; and, iteratively merge any two sequence fragments having matching heads and tails until no further matches are found, and output a sequence assembly process.

The product-by-process described above, wherein said data structure is further characterized in that each indexed row has only one non-zero integer value and said non-zero integer value advances from 1 to k in said rows of said matrix, thereby embedding said natural order.

The product-by-process described above, wherein said data structure includes another column corresponding to a reliability factor indicative of a quality of a base call, such as may be used for ranking fuzzy matches and assemblies.

The product-by-process described above, wherein said product is an exome sequence assembly, a chromosome sequence assembly, or a genome sequence assembly.

The product-by-process described above, wherein said product is a human exome sequence assembly, human chromosome sequence assembly or a human genome sequence assembly.

The product-by-process described above, further comprising annotations.

The product-by-process described above, said product defining a reference sequence specific for gender, ethnicity or ancestry.

### Example 10

A product-by-process, which comprises, a human nucleic acid sequence assembled from sequence fragments by a process of providing a computing machine having a cluster of processors, compilable program instructions, and shared cache memory, wherein said program instructions when executed by said cluster of processors operate to: receive a set of sequence fragments, each sequence fragment defining a string of nucleobases; define a first data structure wherein any string of nucleobases is digitally expressed with embedded natural order in a matrix having k rows by four columns, where k is the number of nucleobases in said string and each column attribute corresponds to a nucleobase residue by type, said matrix constituting a Mercator data structure; define a second data structure constructed by normalizing said first data structure as an matrix of binary strings, each row of said matrix having only one non-zero value, then for n rows beginning with row 1, herein termed a head, and n rows ending with row k, herein termed a tail, vectorize and extract vectors columnwise from said matrix as vector rows, and convert each to an integer in a n×4 signature matrix, said second data structure constituting a Mercator signature; using processor nodes and memory assigned by a database management system to processing said first data structures: construct an indexed table of said data structures for all sequence fragments to be matched, and for every row of said table, construct offset data structures having an offset alignment according to a range of offset values; make a row-by-row search for matching alignments between any offset data structure of a sequence fragment and any data structure or structures of a reference sequence or subsequence; and iteratively merge any two sequence fragments having an overlap of an end sequence when matchingly aligned into an assembly until no further matches are found; in parallel, using processor nodes and memory assigned by said database management system to processing said second data structures for each first data structure representing a sequence fragment, normalize said matrix to binary strings, each row of said matrix having only one non-zero value, then for n rows beginning with row 1, herein termed a head, and n rows ending with row k, herein termed a tail, vectorize and extract vectors columnwise from said matrix as vector rows, and convert each to an integer in a n×4 signature matrix; construct an indexed table of said signature matrices for all sequence fragments to be matched end-to-end, make a row-by-row search for matching between any heads and tails or tails and heads but of multiple matching instances for a single data structure, select only the instance having the greatest k; and, iteratively merge any two sequence fragments into an assembly having matching heads and tails until no further matches are found; and, resolve any differences in said assemblies by increasing a depth of coverage, by ranking said assemblies by a quality factor, or by comparing said assemblies with one or more alternate reference sequences, and output a sequence assembly product.

The product-by-process described above, wherein said first data structure is further characterized in that each indexed row has only one non-zero integer value and said non-zero integer value advances from 1 to k in said rows of said matrix, thereby embedding said natural order.

The product-by-process described above, wherein said first data structure includes another column corresponding to a null or unidentifiable nucleobase attribute, such as may be used for ranking fuzzy alignments and assemblies.

The product-by-process described above, wherein said first data structure includes another column having an attribute for a quality factor, where a zero indicates a gap or an error in said sequence fragment associated with no confidence in a base call, a fraction indicates a base call having a reduced level of certainty, and a null field indicates a proper base call.

The product-by-process described above, wherein said product is an exome sequence assembly, a chromosome sequence assembly, or a genome sequence assembly.

The product-by-process described above, wherein said product is a human exome sequence assembly, human chromosome sequence assembly or a human genome sequence assembly.

The product-by-process described above further comprising annotations.

The product-by-process described above said product defining a reference sequence set specific for gender, ethnicity or ancestry.

The product-by-process described above, wherein said alternate reference sequences are selected from 96 reference sequence sets differentiated by gender, ethnicity and ancestry.

The product-by-process described above 1, wherein said reference sequences corresponding to a set or sets of 23 or 24 pairs of human chromosome reference sequences.

The product-by-process described above, wherein said cluster of processors and shared cache memory define a polynodal cluster having capacity to execute concomitant autonomous instances of program instructions in multi-threaded, streaming, massively parallel computations on said data structures.

The product-by-process described above, wherein each said data structure is manifested in said cache memory as a flat file having a single line of characters.

The product-by-process described above, wherein said product is delivered in less than about 48 hours.

### Example 11

A method for receiving a set of nucleic acid sequence fragments collectively derived by a process of sequencing a specimen, and assembling the set of sequence fragments into longer contiguous reads as carried out in a computing machine having a cluster of processors, compilable program instructions, and shared cache memory, the method comprising: defining a data structure wherein any string of nucleobases is digitally expressed with embedded natural order in a matrix having k rows by four columns, where k is the number of nucleobases in said string and each column attribute corresponds to a nucleobase residue by type, said matrix constituting a Mercator data structure; constructing an indexed table of said data structures for all sequence fragments to be matched, and for every row of said table, constructing offset data structures having an offset alignment according to a range of offset values; making a row-by-row search for matching alignments between any offset data structure of a sequence fragment and any data structure or structures of a reference sequence or subsequence; and iteratively merging any two sequence fragments having an overlap of an end sequence when matchingly aligned until no further matches are found; and filtering to select the best alignments and outputting a completed assembly.

### Example 12

A data structure for operation of a computational sequence assembly process on a computing machine having a cluster of processors, compilable program instructions, and shared cache memory, the data structure comprising a table defining a Mercator Prism, which may be expressed as: SHOEBOX_ID, SZVMTX1, OFFSET, COMPSTRING_ID, SZVMTX2} wherein SHOEBOX_ID defines an first indexed list of sequence fragments; COMPSTRING_ID defines a second indexed list of sequence fragments; SZ\TMTX1 and SZ\TMTX2 define first and second tables wherein a first string of nucleobases selected from said first indexed list of sequence fragments and a second string of nucleobases selected from said second indexed list of sequence fragments are digitally expressed with embedded natural order in each a matrix having k rows by four columns, where k is the number of nucleobases in each said string and each column attribute of said matrix corresponds to a nucleobase residue by type, said matrix constituting a Mercator matrix; OFFSET defines a variable having a range from 0 to P, where P is less than k, the number of rows in said first table; and further wherein said table is ordered in memory so that said cluster of processors and shared cache memory are programmed to define a polynodal cluster having capacity to execute concomitant autonomous instances of said program instructions on said data structure in multithreaded, streaming, massively parallel computations, thereby reducing time for sequence assembly.

The data structure described above, wherein said matrix includes a fifth column having a column attribute “N” for any unidentified base in said first string.

The data structure described above, wherein said matrix includes another column having a column attribute “QP” for associating a quality factor with at least one base of said first string.

The above disclosure is sufficient to enable one of ordinary skill in the art to practice the invention, and provides the best mode of practicing the invention presently contemplated by the inventor. While above is a complete description of some embodiments of the present invention, various alternatives, modifications and equivalents are possible. These embodiments, alternatives, modifications and equivalents may be combined to provide further embodiments of the present invention. The inventions, examples, and embodiments described herein are not limited to particularly exemplified materials, methods, and/or structures. Various modifications, alternative constructions, changes and equivalents will readily occur to those skilled in the art and may be employed, as suitable, without departing from the true spirit and scope of the invention. Therefore, the above description and illustrations should not be construed as limiting the scope of the invention, which is defined by the appended claims.

Having described the invention with reference to the exemplary embodiments, it is to be understood that it is not intended that any limitations or elements describing the exemplary embodiments set forth herein are to be incorporated into the meanings of the patent claims unless such limitations or elements are explicitly recited in the claims. Likewise, it is to be understood that it is not necessary to meet any or all of the identified advantages or objects of the invention disclosed herein in order to fall within the scope of any claims, since the invention is defined by the claims and inherent and/or unforeseen advantages of the present invention may exist even though they may not be explicitly discussed herein.

While the above is a complete description of selected embodiments of the present invention, it is possible to practice the invention using various alternatives, modifications, combinations and equivalents. Some or all of the processes and/or routines may be performed independently. For example, in signature matching where input strings may be automatically assembled by signature may not need use other actions to locate the input strings. Prism match where input strings that did not match by signature are examined for best location and may be further aligned by head/tail matching may be performed independent of any other process. De novo alignment by the prism where the best matches for head/tail alignments of string vs. string and identified and a new specimen alignment is created from raw input data may also be performed independently. Any other process or routine described herein may be performed in conjunction with or independent of any other process or routine. Other combinations, order of steps, and improvements are anticipated to realize further advantages while not departing from the spirit of the invention. In general, in the following claims, the terms used in the written description should not be construed to limit the claims to specific embodiments described herein for illustration, but should be construed to include all possible embodiments, both specific and generic, along with the full scope of equivalents to which such claims are entitled. Accordingly, the claims are not limited by the disclosure.

What is claimed is:

1. A method comprising:
identifying a reference string of nucleobases digitally expressed in a first Mercator data structure having k rows by four columns, wherein k is a number of nucleobases in said string and each column attribute corresponds to a nucleobase residue by type;
creating a first plurality of reference signatures of a predetermined length for the reference string;
receiving an input string of nucleobases to be sequenced;
creating a digitally expression of the input string in a second Mercator data structure having k rows by four columns;
creating a second plurality of reference signatures of the predetermined length for the input string;
comparing each of the second plurality of reference signatures with each of the first plurality of reference signatures to identify possible matches of the second plurality of reference signatures with the first plurality of reference signatures; and
identifying a match between at least one of the second plurality of reference signatures with at least one of the first plurality of reference signatures.

2. The method of claim 1 further comprising storing the match in an indexed table that identifies the input string, a chromosome and an index position of the match.

3. The method of claim 2, wherein the index position of the match is in relation to the reference string.

4. The method of claim 2, wherein the index position of the match is in relation to the input string.

5. The method of claim 1 further comprising:
receiving the reference string; and
creating a digital expression of the input string in the first Mercator data structure.

6. The method of claim 1, wherein the Mercator data structure includes another column corresponding to a null or unidentifiable nucleobase attribute, such as may be used for ranking fuzzy alignments and assemblies.

7. The method of claim 1, wherein Mercator data structure includes another column corresponding to a reliability factor indicative of a quality of a base call.

8. The method of claim 1, wherein the reference string is an exome, a chromosome, or a genome.

9. A system comprising:
a memory; and
a processor operatively coupled to the memory, the processor configured to perform operations comprising:
identify a reference string of nucleobases digitally expressed in a first Mercator data structure having k rows by four columns, wherein k is a number of nucleobases in said string and each column attribute corresponds to a nucleobase residue by type;
create a first plurality of reference signatures of a predetermined length for the reference string;
receive an input string of nucleobases to be sequenced;
create a digital expression of the input string in a second Mercator data structure having k rows by four columns;
create a second plurality of reference signatures of the predetermined length for the input string;
compare each of the second plurality of reference signatures with each of the first plurality of reference signatures to identify possible matches of the second plurality of reference signatures with the first plurality of reference signatures; and
identify a match between at least one of the second plurality of reference signatures with at least one of the first plurality of reference signatures.

10. The system of claim 9, the processor being further configured to store the match in an indexed table that identifies the input string, a chromosome and an index position of the match.

11. The system of claim 10, wherein the index position of the match is in relation to the reference string.

12. The system of claim 9, wherein the index position of the match is in relation to the input string.

13. The system of claim 9 further comprising:
receiving the reference string; and
creating a digital expression of the input string in the first Mercator data structure.

14. The system of claim 9, wherein the Mercator data structure includes another column corresponding to a null or unidentifiable nucleobase attribute, such as may be used for ranking fuzzy alignments and assemblies.

15. A non-transitory computer readable storage medium comprising instructions that, when executed by a processor, cause the processor to perform operations comprising:
identify a reference string of nucleobases digitally expressed in a first Mercator data structure having k rows by four columns, wherein k is a number of nucleobases in said string and each column attribute corresponds to a nucleobase residue by type;
create a first plurality of reference signatures of a predetermined length for the reference string;
receive an input string of nucleobases to be sequenced;
create a digital expression of the input string in a second Mercator data structure having k rows by four columns;
create a second plurality of reference signatures of the predetermined length for the input string;
compare each of the second plurality of reference signatures with each of the first plurality of reference signatures to identify possible matches of the second plurality of reference signatures with the first plurality of reference signatures; and
identify a match between at least one of the second plurality of reference signatures with at least one of the first plurality of reference signatures.

16. The non-transitory computer readable storage medium of claim 15, the processor being further configured to store the match in an indexed table that identifies the input string, a chromosome and an index position of the match.

17. The non-transitory computer readable storage medium of claim 16, wherein the index position of the match is in relation to the reference string.

18. The non-transitory computer readable storage medium of claim 15, wherein the index position of the match is in relation to the input string.

19. The non-transitory computer readable storage medium of claim 15 further comprising:
receiving the reference string; and
creating a digital expression of the input string in the first Mercator data structure.

20. The non-transitory computer readable storage medium of claim 15, wherein the Mercator data structure includes another column corresponding to a null or unidentifiable nucleobase attribute, such as may be used for ranking fuzzy alignments and assemblies.
